(19) United States
(12) Patent Application Publication
(10) Pub. No.: US 2017/0304024 A1
(43) Pub. Date: Oct. 26, 2017

(54) INTRAORAL VIBRATORY MULTIFUNCTIONAL DEVICE AND WIRELESS SYSTEM FOR INTERACTION BETWEEN DEVICE, PATIENT, AND DENTIST

(71) Applicants: Celestino José Prudente Nóbrega, São José dos Campos (BR); Gustavo Ravanhani Matuck, São José dos Campos (BR); Jorge Luís Guedes Alves, São José dos Campos (BR); Rogério Amaral Tupinambá, Socorro, Pindamonhangaba (BR)

(72) Inventors: Celestino José Prudente Nóbrega, São José dos Campos (BR); Gustavo Ravanhani Matuck, São José dos Campos (BR); Jorge Luís Guedes Alves, São José dos Campos (BR); Rogério Amaral Tupinambá, Socorro, Pindamonhangaba (BR)

(21) Appl. No.: 15/526,228

(22) PCT Filed: Nov. 11, 2014
(86) PCT No.: PCT/IB2014/065961

§ 371 Date: May 11, 2017

(51) Int. Cl. A61C 7/00; A61C 7/08; A61C 7/20

(52) U.S. Cl. CPC A61C 7/008; A61C 7/20; A61C 7/002; A61C 7/08

(57) ABSTRACT

The intraoral vibratory multifunctional device and wireless system for interaction between device, patient, and dentist, which stands out, among other things, for being comprised by independent segments, so that the applicability of the activation protocols by isolated segments of the arch becomes very simple, and can also be activated together, all segments simultaneously. In short, the invention provides a broad and real time relationship between the dental professional and the patient, in addition to offering other entertainment which could possibly be used. The invention consists of a dental device that has vibration characteristics by means of vibration and a clamping element attached to the dental arch or braces, with the dental braces (AP) composed of microvibrators (1), vibration band (2), and sensors (S1). A remote interaction system provides interactive communication between patient (P), dentist (D1), and the system itself. In short, the invention provides a broad and real time relationship between the dental professional and the patient, in addition to offering other entertainment which could possibly be used.

### A BRIEF SUMMARY OF THE INVENTION

This invention patent request comprises an intraoral vibratory multifunctional device and a wireless device and dental patient interaction system, which stands out, among other items, by the fact that the said device is a receiver for sensors and microvibrators operated by dedicated hardware and software, so that the applicability of activation protocols for isolated segments of the arch becomes very simple. All microvibrators may also be activated simultaneously together. In short, the invention provides a broad and real time relationship between the dental professional and the patient, in addition to offering other entertainment which could possibly be used. Due to this constructiveness, the invention further provides means for treating pain from specific vibration protocols that have an analgesic function. The device includes, in addition to this pain treatment, through a vibration and intraoral parameter measurement system through sensors, an important application in orthodontic acceleration and oral health monitoring, including osseointegration and implants.

Another positive aspect of the invention is that its construction allows, with a single unit, a dual use capacity; in other words, both as a bite plate and when applied directly to the orthodontic arch (when the bite plates are removed).

Other important features are associated with this inventive process, such as the fact that the object of this invention has a lower volume and does not require any extraoral accessory for fixation and stabilization when compared to other similar devices, something that can facilitate the issue of patient collaboration.

### Field of the Invention

The intraoral device and its interaction system, the objects this invention patent request, have a field of application focused on the medical and dental industries—within the latter, in specialties such as orthodontics, surgery, periodontics, endodontics, implantology and other areas where bone metabolism and tissue repair acceleration processes are present, in addition to the detection of systemic diseases and the reduction of pain conditions associated with these specialties.

### State of the Art

Orthodontics seeks correct dental positioning, targeting functions and aesthetics that are appropriate to each individual. In orthodontic treatment, light forces are applied to the teeth by using a specific orthodontic device, that is, braces.

The length of this treatment depends on various factors, such as: the biological response of the patient, the amount of force applied, for how long these forces act, the complexity of the case, patient cooperation and other factors.

An orthodontic treatment has an average duration of 18 to 30 months, depending if dental extractions are required, something that tends to extend the treatment even further.

Among the most common complaints by patients who undergo orthodontic treatments are the discomfort related to the device being present, the soreness originating from the inflammatory response associated to tooth movement and the duration of such treatment.

Several researches have been carried out in order to reduce such complaints, reducing discomfort and accelerating tooth movement through an application of pulsating forces.

Authors such as Lundeberg (1984) observed that the analgesic effect of a vibratory stimulus was more effective than aspirin in regard to relieving pain due to orthodontic movement. Ottoson et al. (1981) also reported the relief of pain caused by other dental problems, such as pulpitis and postoperative pain.

Nishimura et al. (2008), when conducting an experimental study regarding vibration in rat teeth subjected to orthodontic forces, observed significantly higher tooth movement in the experimental group than in the control group.

Thus, based on literature, devices that apply a vibration effect on the teeth associated with orthodontic appliances have been developed, with a focus on reducing pain and treatment duration.

Among devices already available for these ends we can name Acceledent (Pat. US20120040300, US20120322018), which consists of a fork-shaped device that adapts to the teeth by occlusion (bite) and an external device that has the role of producing the vibration effect, transmitting it to the fork and also collecting data regarding the frequency of use and patient cooperation. Another device is also part of the kit and has the role of transmitting the data collected and recharging the battery of the vibrating device. This fork-shaped device has, at first sight, problems related to its use, but primarily comprises as predominant features aspects related to the impossibility of a segmented vibration effect that target specific areas of the oral cavity.

There is also another device (Pat. US20110007920) on which the vibrating device is incorporated to a plate that is bitten by the patient so the vibratory stimulus can be directed to his or her teeth. In this device, it is possible to choose which teeth will receive the stimulus in an isolated or joint fashion. However, the insertion of these vibrating devices is done directly between at least two teeth, something that is not very comfortable for the patient. This is also performed on a one by one basis, incurring a slow process for both the patient and the dental professional.

Other devices (U.S. Pat. No. 4,348,178 and US20090061375) employ the encapsulation of the whole teeth/appliance set or only the teeth so the vibratory stimulus can be distributed throughout the dental arch. These devices employ the use of external leads that feed the vibrating device and, in U.S. Pat. No. 4,348,178, there is also a device which holds the assembly in position, being attached to the teeth by means of an external support which extends out to the neck of the individual. Devices that employ encapsulation, besides employing external means of support, incur issues related to their installation, use and comfort for their users, as well as difficulties for the professionals. Also, they do not allow you to efficiently select the exact area that will benefit with the treatment, nor any modification of the areas to be treated within a full concept of efficiency, primarily via a wireless communication that could be applied to the treatment.

More simplified designs may be seen in U.S. Pat. No. 8,333,203, in which the transmission of the vibrating stimulus is performed by means of sound waves; that is, in this device a set of teeth is encased by a material that is moldable to tooth contours and receives the vibrating stimulus from a device associated to the moldable material. The control that triggers the vibrating device is described separately, allowing it to be adapted when appropriate to the type of use intended. The process described therein is based on an installation technique completely different from this invention patent request, besides conditioning the result to the application form of the moldable material, something that requires very skilled labor.

That is, in the state of the art, regardless of design, type or manner in which the device is supported on the teeth, all have the same purpose: distributing the vibration stimulus to the teeth and, from these, to the bones, so that the desired effects can be obtained. Nonetheless, this purpose is not the object of a patent.

In this invention patent request, the solution found is different from the previously mentioned, considering it relies on a vibratory stimulus with sensors and vibrators associated with a wireless communication, by means of vibrating straps connected to the orthodontic appliance and/or teeth through plans bite plates or clips, with this operation being controlled by dedicated software with great efficiency. This wireless communication and patient data collection technology can be added to others that already exist, such as “Invisalign”, which promotes tooth movement without using traditional brackets and without having as an objective the acceleration of tooth movement.—Additionally, it should be highlighted in this invention that the remote activation of the device is enabled, in addition to a greater efficiency in collecting cooperation and systemic data through an automated process that captures usage data from the dentist and the patient, as well as from the dental appliance.

### PROBLEMS RELATED TO THE STATE OF THE ART

One of the major problems for these devices that currently available is the financial factor. Since they have a highly complex development and according to the type of data available in devices such as Acceledent, their cost reaches 30% of the total amount of a simple treatment. This is a device with many resources but also with a very high cost. On the other hand, it is not a device that allows the vibration to be applied through segmented elements, which, when applying the technique, is a very negative factor when compared to what this invention proposes as something new.

Other devices stumble upon the patient cooperation factor, since they are very bulky and uncomfortable. These have also other drawbacks such as external leads or even neck support splints, which are still quite unsightly (U.S. Pat. No. 4,348,178).

Another factor is the difficulty in adopting a protocol so only specific parts of the arch are stimulated. Only US20110007920 has such capacity, but due to its design, which invades internally the oral cavity, occupying the space of the tongue, it becomes quite uncomfortable and reduces patient acceptance.

This need for stabilizing the device in the oral cavity through biting can be considered a factor for loss of use motivation, since in vibration protocols that require device maintenance while in contact with the teeth for several minutes, patients tend to report muscle fatigue due to maintaining the stabilizing force for too long.

Moreover, state of the art devices do not allow the association of several aspects that are incorporated in this invention, such as wireless communication and data collection via sensors distributed along the device, which establishes an easier communication and the transmission of all data collected, as well as the possibility of implementing specific pain reduction protocols, with this whole procedure performed in real time and without interference by the dentist. Another feature of this invention, not covered by the devices in the state of the art, is the possibility of gaming interaction and music playlists and of controlling treatment evolution through photos.

Devices in the state of the art, such as Acceledent, have no pressure sensors and only vibration systems, something that can be not entirely efficient, since, depending on the amount of pressure applied by the patient's bite, this vibration can either be absorbed (something not interesting for the treatment) or propagated.

### GENERAL DESCRIPTION OF THE INVENTION

One of the major challenges in creating a device of this kind is the difficulty in associating a small volume simplified design with easiness in use, patient cooperation and vibratory effectiveness, along with the possibility of including the following solutions:
the effectiveness of orthodontic treatment, osseointegration and implants;
an effective communication between the dentist and the patient;
traceability, control and transparency regarding treatment information;
supporting the patient while dealing with teeth pain, through vibration protocols that have an analgesic function;
entertainment with music and games during the treatment;
a smart system that learns the behavior from the dentist and the patient to support decisions;
regarding the dentist, the system will suggest treatment plans for an specific type of patient, as well as monitor the treatment progress for each patient, suggesting possible changes in the protocols being used;
regarding the patient, the system may, for example, suggest which time of the day is the most effective for the treatment, suggesting pain protocols according to treatment progress, taking into consideration that each pain protocol can have a different effect for every patient;
all monitoring is carried out remotely and in real time.

Thus, with the integration of the strap design with vibrating devices spread across segments, it was possible to provide versatility to the device, since it has two options for distributing vibrational stimuli: bite plates and sliding fixing clips. The sliding clips, when attaching themselves to the orthodontic appliance, transmit forces directly to it, without the need for any concern about the bite, something that only larger volume and more complex and expensive devices partially offered.

Another distinguishing feature of the invention lies in the way these clips slide through the vibrating strap, allowing the vibrating device to be adapted to any type of vestibular dental appliance, regardless of the malocclusion type or of spaces present between brackets, either on the upper or lower arch.

Furthermore, it is possible to replace the clips when needed, as well as use as many as needed for a better device fixation. The second fixation option, presented by bite plates which are also attached to the strap, is indicated beyond the conventional orthodontic appliances carriers to users of lingual orthodontic appliances and custom dental aligners such as Invisaling. This option also enables the use of the device by patients who are not users of orthodontic appliances and who seek to take advantage of other benefits associated with the device, besides the acceleration of tooth movement.

### ADVANTAGES OF THE INVENTION

This invention, as already explained, is comprised of a device that is a receiver for sensors and microvibrators operated remotely by dedicated hardware and software, so that the applicability of activation protocols for isolated segments of the arch becomes very simple, with these microvibrators having the capacity of being simultaneously activated. In short, the invention provides a broad and real time relationship between the dental professional and the patient, in addition to offering other entertainment which could possibly be used. Due to this constructiveness, the invention further provides means for treating pain from specific vibration protocols that have an analgesic function. The invention, in addition to collecting data through sensors, also stands out by incorporating features such as wireless communication, Bluetooth and even games and music integrated to the device control software.

Its construction, dedicated to the treatment with orthodontic appliances bonded to the outer (vestibular) teeth face, eliminates the need to stabilize the patient's bite, since the device has sliding clips that attach directly to the arch of the dental appliance, thus reducing patient fatigue and increasing the rate of their cooperation.

Also, being composed of independent segments, the applicability of activation protocols by isolated arch segments becomes very simple; these segments can also be activated together simultaneously.

Finally, the invention can be considered a revolution in this industry, notably by inserting a device that combines remote communication, the transmission of data and a communication with the professional via the device control application, with specific pain reduction protocols.

### DESCRIPTION OF DRAWINGS

The invention will be hereinafter explained in a preferred embodiment, wherein, for better understanding, references will be made to the accompanying graphics in which are shown:

FIG. 1: Top view of the device attached to the orthodontic appliance, in a building with bite plates.

FIG. 2: Top view of the device with a strap and the clip option attached to a conventional (vestibular) orthodontic appliance, an alternative to the bite plates.

FIG. 2A: Top view of the strap arch and the sensor locations.

FIG. 2B: Details of the clips used in FIG. 2.

FIG. 3: Top view of the bite plates with pressure sensors.

FIG. 4: Front view of the device with sensor arrangement.

FIG. 5: Side view of the device with sensor arrangement.

FIG. 6: Schematic drawing of the device connected to the operating system in both patient and dentist links.

FIG. 7: Overview of the device integrated to the system, including the business, Internet, software, logistics, secretaries/dentists and patients, as well as the hardware.

FIG. 8: Overview of the device integrated into the system, including the device user, software and hardware.

FIG. 9: Overview of hardware in component levels.

FIG. 10: Overview of the dental appliance identifying its main components.

FIG. 11: Shows the mode of operation of the microvibrators in three scenarios taken as an example—in other words, side and front microvibrators, frontal microvibrator and side microvibrators, showing which ones are operating in each mentioned scenario.

FIG. 12: Shows an overview of the information flow security.

FIG. 13: Shows an overview of dentist functionalities.

FIG. 14: Shows an example of patient control by the dentist.

FIG. 15: Shows dental appliance user patient functionalities according to the invention system.

FIG. 16: Shows secretary/device assistant functionalities.

FIG. 17: Shows the application of artificial intelligence in the device and its system, according to the invention.

FIG. 18: Shows the device/system integration with games and music.

FIG. 19: Treatment execution in a preferred version flow.

FIG. 20: Sponsored ad space flow.

FIG. 21: Information access flow.

FIG. 22: Message exchange with the dentist flow.

FIG. 23: Continuous treatment questionnaires flow.

FIG. 24: Dentist registration flow.

FIG. 25: Device battery autonomy alert flow.

FIG. 26: R&D flow-receiving treatment diagnostics and prognostics.

FIG. 27: Access and run games flow.

FIG. 28: Message exchange with patients flow.

FIG. 29: Patient oral health monitoring flow.

FIG. 30: Device app interface customization flow.

FIG. 31: Patient protocol modification flow.

FIG. 32: Treatment photo acquisition flow.

FIG. 33: Next visit to the dentist alert flow.

FIG. 34: Continuous treatment information access flow.

FIG. 35: Patient smile image viewing flow.

FIG. 36: Pain treatment execution flow.

FIG. 37: Device in use sensor and microvibrators malfunction flow.

FIG. 38: Enabling and disabling patient message exchange flow.

FIG. 39: Associating and disassociating patients flow.

FIG. 40: Patient registration flow.

FIG. 41: Access to questionnaires answered by patients flow.

FIG. 42: Music listening and playlistsmanagement flow.

FIG. 43: Music selection flow.

FIG. 44: Patient visit booking flow.

FIG. 45: Device connection flow.

FIG. 46: R&D flow-receiving alerts regarding active patient treatments.

### DETAILED DESCRIPTION

The intraoral vibratory multifunctional device and wireless system for interaction between device, patient, and dentist, which are the object of this invention patent request, comprise a device (AP) composed by microvibrators (1) and a vibration strap (2), also including sensors (S1) for specific parameters; this device is integrated to a system that enables the interaction between patient (P) and dentist (D1), using software (S) and hardware (H) for the patient and the dentist, as well as the Internet, with features such as wireless and Bluetooth, to send and receive database (BD) information about the process, thus enabling data to be collected and the control of various functions from the device. The device (AP) has the format of the oral cavity and receives internally a vibration strap (2) which circumvents it internally (IMGs. 1 and 2).

For the clarification and exemplification of system operational possibilities, sensors (S1) used in the appliance (AP) can be different in nature, such as: bite pressure sensors (S1′), oral temperature sensors (S1″), ketone bodies sensor (S1′″) and pH sensor (S1″″), with this being a preferred and detailed embodiment of the invention.

The appliance (AP) receives a connection of peripheral devices to its vibration strap (2) in order to transmit the stimulus to the teeth/appliance set; among these accessory devices are bite plates (PM) (IMGs. 1 and 2), on a first build, and securing clips (3A), on a second build.

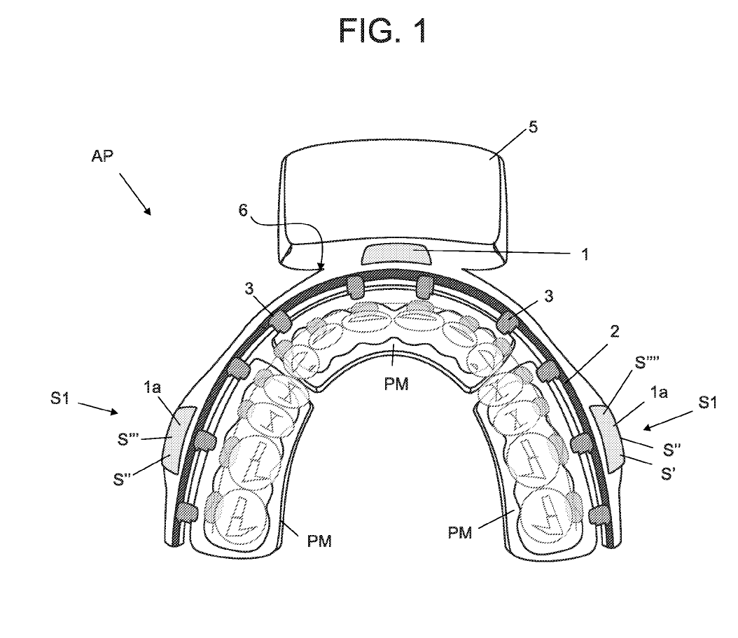

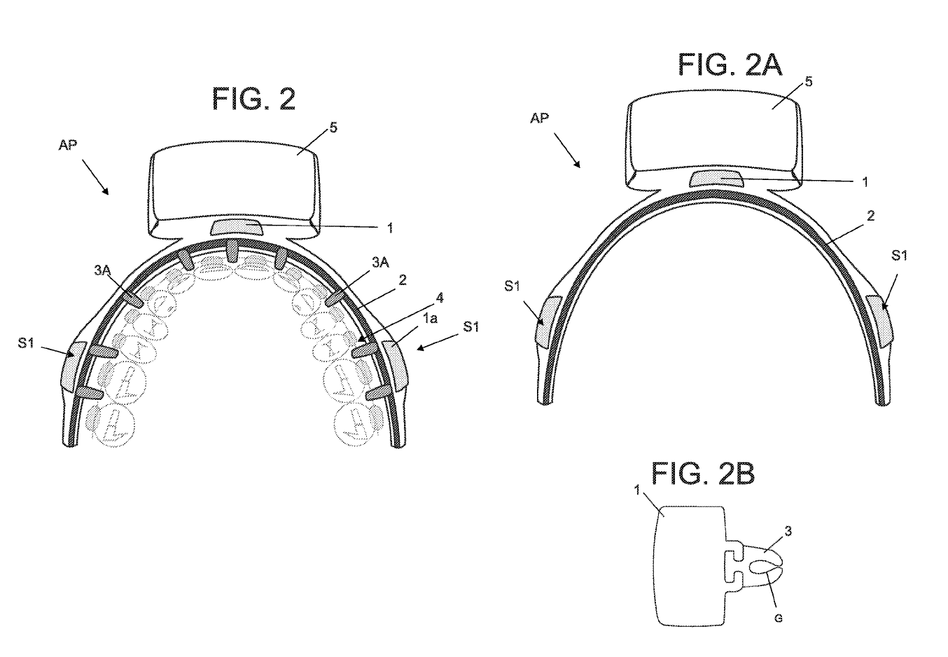

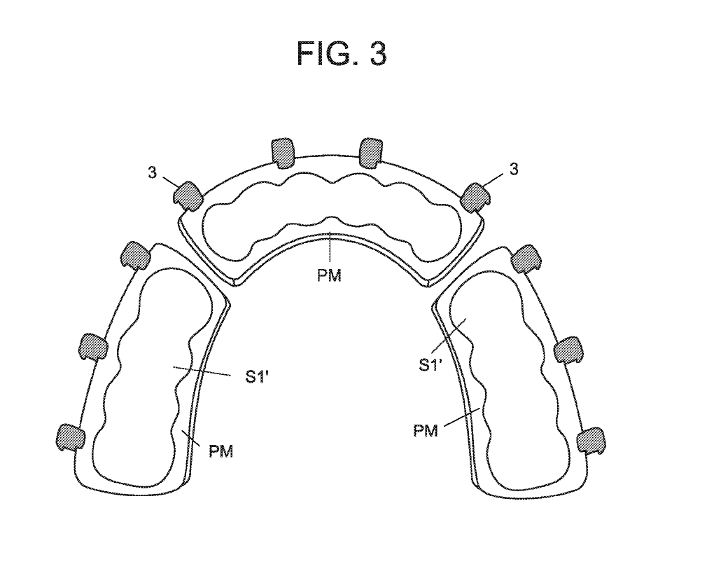

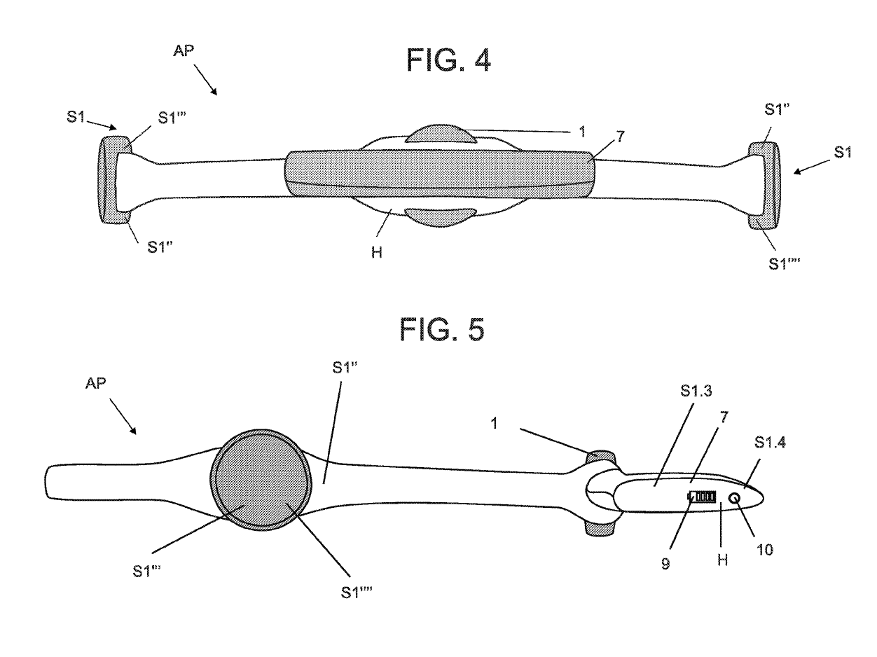

There are at least three microvibrators (1), one anterior (1) and two posterior or lateral (1a). On the first build shown in this invention (FIG. 1) at least three bite plates (PM) are used, namely a central anterior and two posterior or lateral, which are compatible with microvibrators (1). The said bite plates (PM) are connected to the vibration strap (2) by means of clips (3), while alternatively (FIG. 2), the bite plates (PM) are replaced by clips (3A) directly attached to the vibration strap (2) and to a conventional orthodontic appliance (4).

In front of the appliance (AP) is a receptacle (5) attached to the appliance (AP) outer rim (6), in which some operational components of the appliance are housed; this said housing (5) and the said outer rim of the appliance (6) are made of a plastic material which accepts a slight deformation and, at the same time, seals the inner assembly, isolating it from mouth fluids. Also, sensors (S1) are inserted in the outer rim of the appliance (6) and are distributed alongside microvibrators (1) for the collection of oral parameters. In this receptacle (5) are also housed the hardware for controlling vibrations and other sensors, the Bluetooth communication hardware, a gyroscope and an accelerometer, plus at least one battery (7), an electronic circuit (8), a LED indicator (9) and a reset button (10) (FIG. 5).

The vibration strap (2) is made of a plastic material and is intimately attached to the vibration set or microvibrators (1), becoming a part of these, as shown in IMGs 1, 2 and 2A. In other words, the vibration strap (2) extends itself through the whole appliance and joins the microvibrators (1), as shown in IMGs 1, 2 and 2A.

To adapt the vibratory device in patients with internal (lingual) orthodontic appliances (FIG. 1) and aesthetic aligners, or to appliances that preclude its attachment to the outer arch through clips (3A), bite plates (PM) should be used so that the vibratory stimulus from the microvibrators (1) can be carried to the teeth and from these to the structures that support them (periodontal ligaments and bones), where tooth movement process take place.

For adapting the vibratory device (AP) to patients with conventional orthodontic appliances, the securing clips (3A) should be used, as indicated by FIG. 2.

The aforementioned securing clip (3A) has its design and size according to FIG. 2, that is, it attaches itself to vibration strap (2) as if in a rail, with free glide over its entire length. Technically, many clips (3) can be adjusted as necessary for the vibration device to perfectly fit the arch, and this to the orthodontic appliance.

The clip (3A), design, according to what is shown in FIG. 2B, favors an adaptation of this clip (3) to any type and caliber of orthodontic wire, particularly due to its internal teardrop-shaped (G) design with an internal gap that ranges from 0.1 mm to 1.0 mm, making this said clip versatile (3) and assigning it clamp properties.

The bite plates (PM) are provided in two different sizes, to be used in the anterior portion of the arch and in the posterior or lateral portion, both of which have also securing clips (3) that attaches them to the vibrating strap (2) and allows them to glide down its whole length. These bite plates are flat and made of a thermoplastic material, so they can be shaped according to the patient's bite before being used.

The vibration frequency of the device will be, in a first form of treatment, between 40-60 Hz and, in a second form of treatment, between 100-120 Hz. Changes in frequency values will be made through changes in protocols (continuous treatment protocol and pain protocol), according to flows described in attached IMGs 19-47. In other words, the patient may not modify the frequencies and the dentist can only perform this change by switching between specific protocols.

Associated with the use of the vibration device is a specific protocol for the duration of vibratory stimulus, the update frequency and specific activation locations for each patient, according to the phase of treatment he or her is in. An app for mobile phone, tablet or other means that enables communication with the device (AP) will guide the patient so he or she can proceed with the most appropriate protocol for his or her case, informing about how to proceed in every possible treatment variable. This app will be available for free to all invention device users, for IOs, Android and Windows Mobileplatforms.

For this purpose, software (S) and hardware (H) for the patient (P) and the dentist (D1) will be used, as well as the Internet (including known features such as wireless, Bluetooth and others), to send and receive information from the process database (BD), establishing application environments.

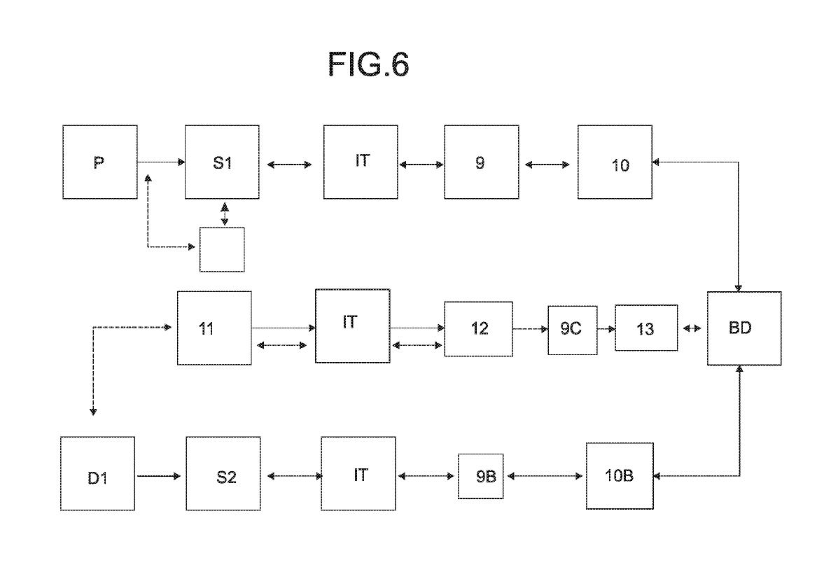

FIG. 6 illustrates the so-called interactive system, through a presentation of the process flow diagram that includes the patient (P) and the dentist (D1), wherein the device (AP) is connected to the patient (P) software (S1), once it has been installed to the latter.

The software (S) operates via the Internet (IT), in which, through login/password (11), web services (12) are responsible for taking information to the process database (BD). The dentist (D1) has his or her machine with a software (S) that also operates via the Internet (IT), in which, through login/password (11B), web services (12B) take information to the process database (BD). There is an access system by the dentist (D1), through a computer (13) that operates on the Internet (IT) and the latter on the process web portal (14) and, through login/password (11C), it communicates with the dentist access restricted process web system (13), which exchanges information with the process database (BD), which is also reached by information originating from the patient (P) and the dentist (D1).

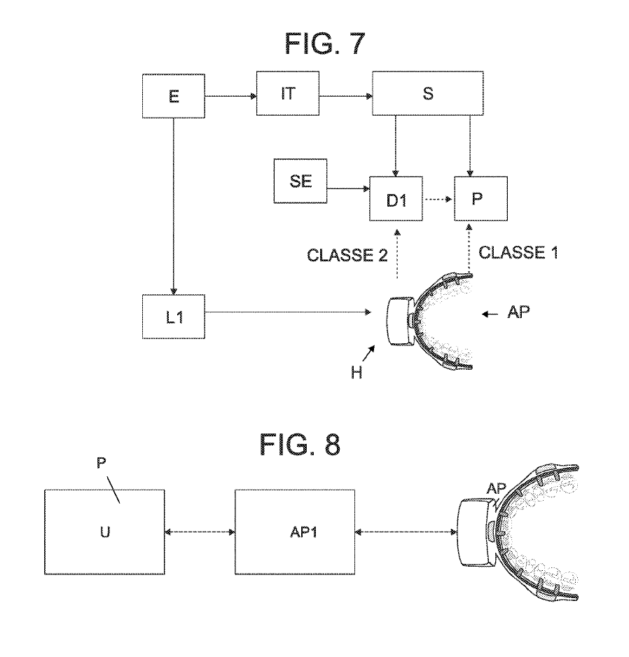

FIG. 7 shows an overview of the product, including the device and the system, under a commercial presentation view, in which the company (E) provides the software (S) for download over the Internet (IT). Through logistics (L1), the hardware device (H) is marketed directly to the patient (P) (if it has been framed as class 1) or to the dentist (D1) (if it has been framed as class 2). This definition of classes 1 or 2 is a matter of choice and has as its sole purpose an operational definition. In this image you can see the secretary (SE) on a call to the dentist (D1), as well as the device (AP).

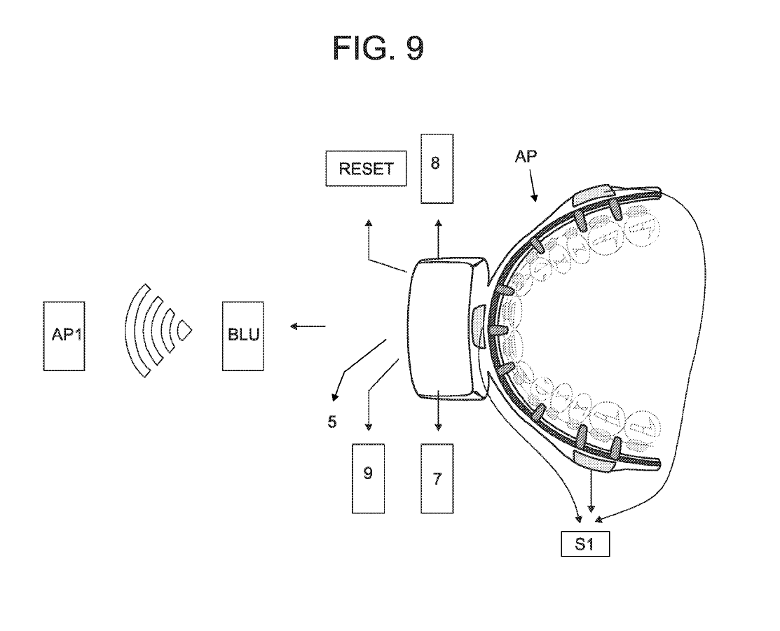

FIG. 9 shows an overview of the hardware in a components level, being exemplified the device (AP), microvibrators (S1) as well as the components contained in the receptacle (5) and the interaction with the application software (AP1) making use of a Bluetooth (BLU) feature, for example.

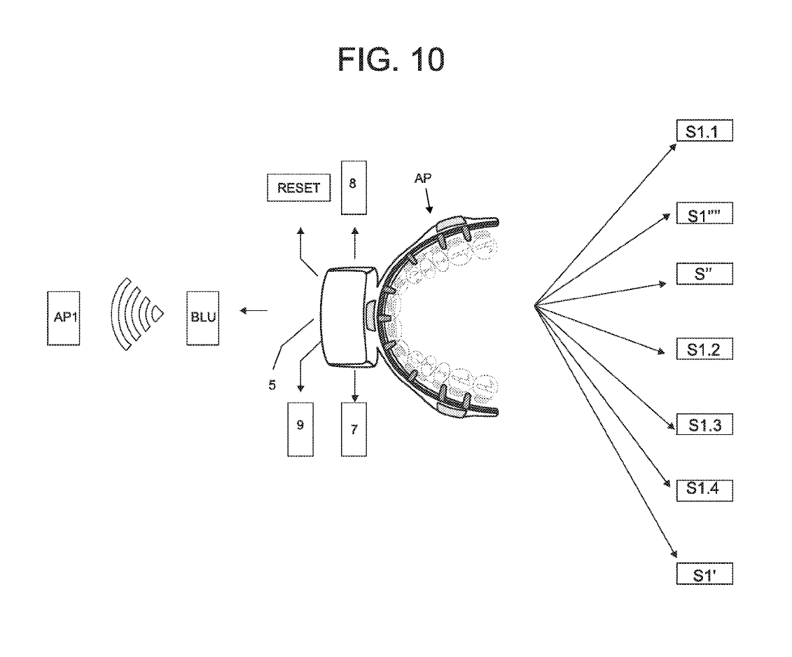

FIG. 10 shows an overview of the dental appliance (AP), its communication with the software (S), illustrating some sensor and microvibrator types (S1) employed, with at least three microvibrators (S1.1), pH sensor (S1″″), oral temperature sensor (S1″), motion sensor (S1.2), gyroscope and accelerometer (S1.3), GPS (S1.4) and bite pressure sensor (S1′).

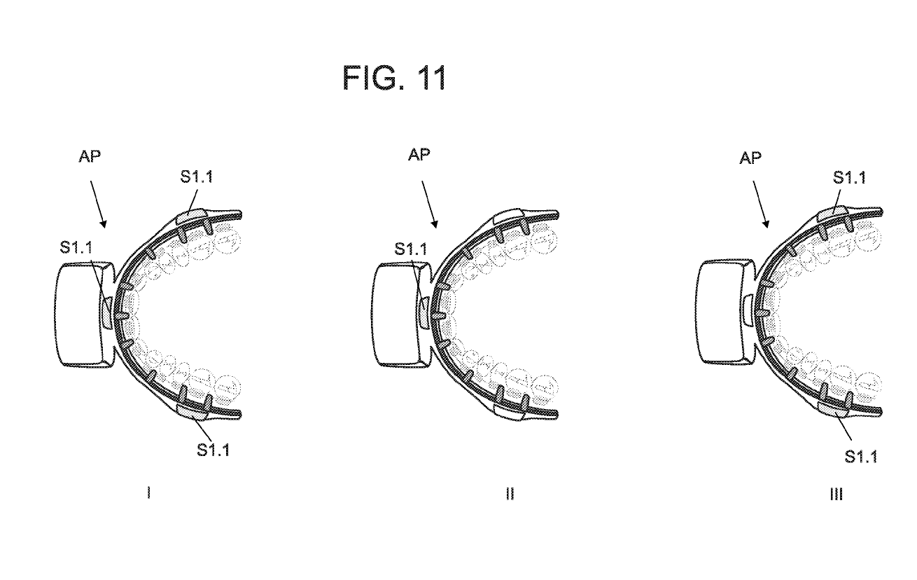

FIG. 11 shows an exemplary mode of operation of device (AP) microvibrators (S.1.1), which illustrates three scenarios for the purpose of understanding: In the first scenario (I), one frontal microvibrator and two lateral microvibrators are provided, with all of them vibrating; in the second scenario (II), the device (AP) only vibrates a single frontal micromotor and, in the third scenario (III), only two lateral micromotors vibrate.

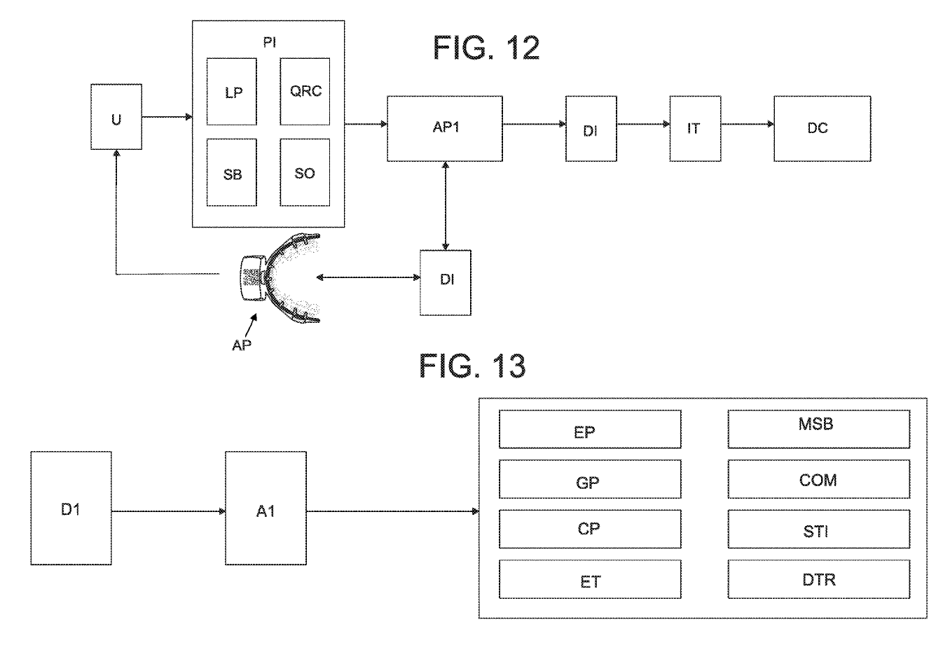

FIG. 12 shows, as an example, an overview of the product's information security, with the user (U) (patient or dentist) being identified as one who communicates with an identification protocol (IP)—which may include several known features such as: Login/password (LP), QR Code (QRC), biometric sensor (SB), eye scanner (SO), among others—for accessing the system application (AP1), in which the user (U), through the device (AP), through encrypted data (DI), accesses the application (A1) and this, through encrypted data (DI), communicates with the Internet (IT) and this with the system Data Center (DC).

FIG. 13 shows, as an example, the main features that the dentist (D1) has in the system application (A1). According to this example, the dentist (D1) can view, in one place, how are his or her patients (P), if there are care points, treatment monitoring and communication, among others. The following can be exemplified among these parameters: edit profile (EP), patient management (GP), permission controls for the secretary/assistant (CP), patient treatment evolution (ET), patient oral health monitoring (MSB), the communication between secretary and patient (COM), issues concerning treatments shared with other dentists (STI), decisions regarding treatments (DTR).

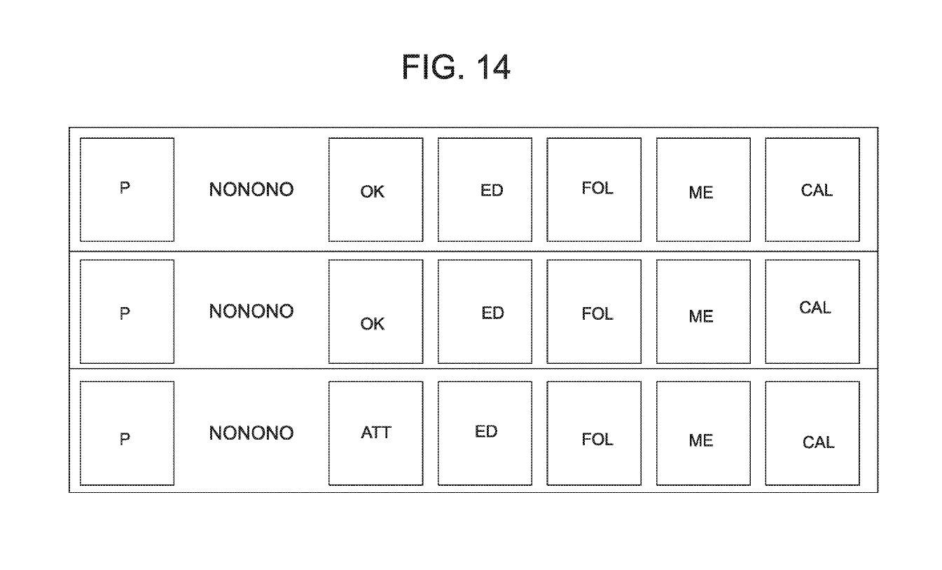

FIG. 14 shows an example of patient control by the dentist (D1) through the device application (A1), with specific items for each patient (P) such as: OK (OK), attention (ATT), follow (FOL), message (ME) and calendar (CAL).

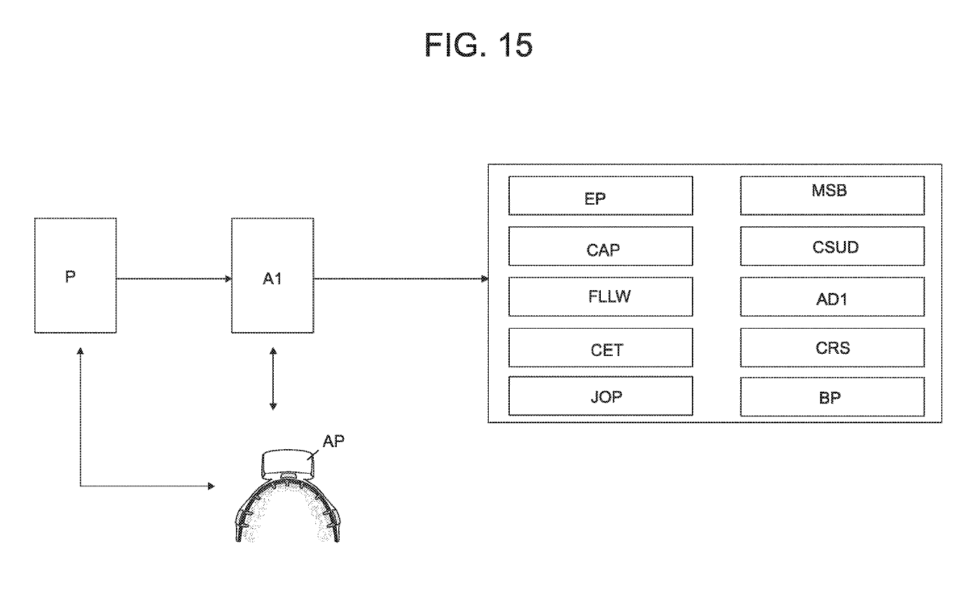

FIG. 15 shows an example of patient (P) functions in the device (AP) application (A1). Among the possible parameters, we can highlight a few without altering the scope of the invention: edit profile (EP), device control (CAP), follow the treatment (FLLW), patient treatment evolution control (CET), games with other patients (JOP), communication with your dentist (CSUD), data analysis (AD1), issues concerning treatments shared with other dentists and social networks (CRS), as well as a panic button (BP).

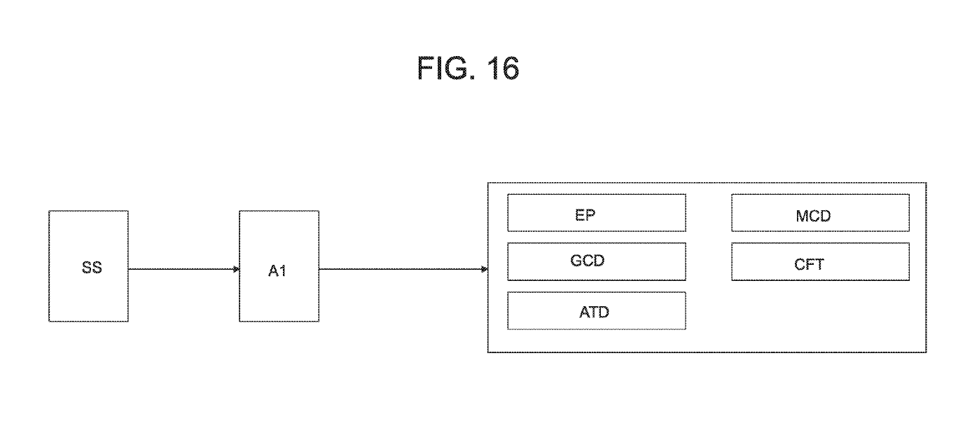

FIG. 16 shows, for example, the secretary/assistant functionalities of the device application (A1), identifying the secretary (SS) and the application (A1). Among the possible parameters, we can highlight: edit profile (EP), dentist calendar management (GCD), answering questions by the patient (ATD), communication messages for the dentist (MCD), patient treatment financial control (CFT).

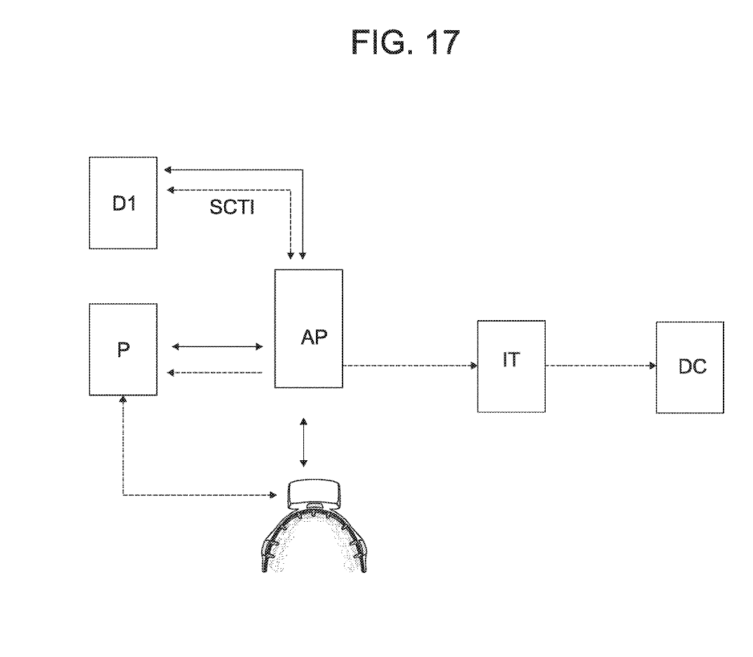

FIG. 17 the application of artificial intelligence in treatment diagnosis and prognosis, with the aim to provide an intelligent and automated support to decision making by the dentist (D1) and the patient (P). According to this example image, given a scenario in which the patient (P) uses the software and the dental appliance (AP), while the dentist (D1) also uses this software (identified by solid arrows—SCTI). Thus, all monitored information in motion is transferred via the Internet (IT) (during pre-scheduled periods) to a server (data center—DC). Information is handled and processed by algorithms and computational models that learn the behavior of treatment plans and of the device being uses, inferring about the data. Through the execution of computational models, predictions for the dentist (D) are created, such as treatment plans for new patients as well as adjustments and corrections for treatments that are already underway. For the patient (P), suggestions for the use of the dental appliance are created according to the treatment progress, aiming to seek a greater effectiveness in this aforementioned treatment.

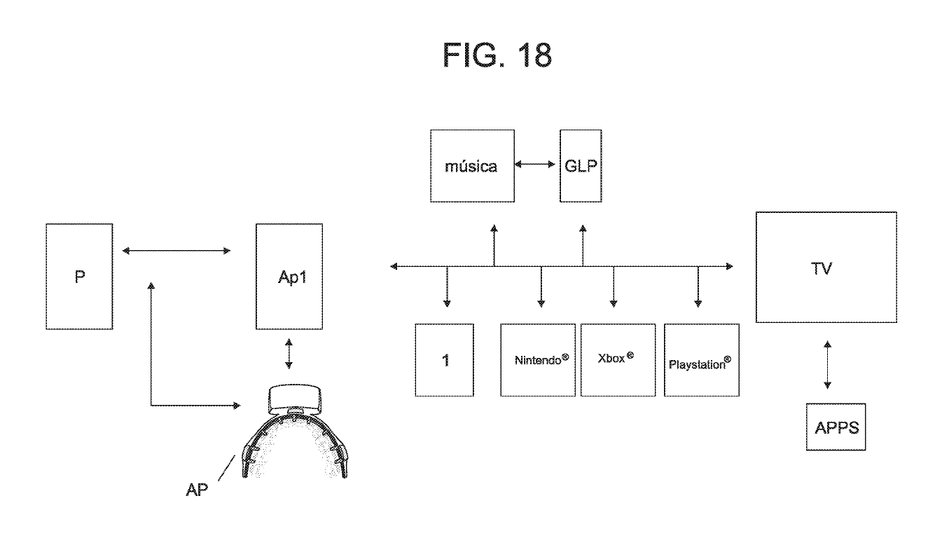

FIG. 18 shows patient (P) entertainment with the invention device (AP), that is, during the use of the dental appliance (AP) by the patient (P), he or she may, through the control device apparatus (tablet, smartphone), listen to music, to radio, manage playlists (GLP), run custom games for the device (AP) application (1), run third party games such as Xbox®, Nintendo® and Playstation®, as well as run games through a Smart TV.

Before we get into the detailed luxuries and running the features of this invention, there is place for a clarification on the requirements for software development. Technically, in the embodiment of this invention, there are four users: the patient (P), the secretary/assistant (SEC), the dentist (D1) and the administrator (ADM). Described below are, according to one embodiment exemplified herein, the system requirements. In the patient (P) group, requirements for account management (417), dental device (418), orthodontic treatment (419), entertainment (420) and communication (421) are provided. In the secretary/assistant group, general (422) and dental care (423) requirements are provided. In the dentist (D1) group, account management (424), patient control (425) and orthodontic treatment (426) requirements are provided. In the administrator (ADM) group, the general (427) item is provided. A system (428) group and a general communication (429) group is also provided.

The general communication (429) group has the following requirements:
share information (images and experiences, except clinical data) about the treatment with other patients;
share the treatment progress in social networks (images and experiences, except clinical data);
ask questions about the treatment to your dentist and/or secretary/assistant (with permission from the dentist);
schedule appointments and receive alerts (subject to approval by the dentist/secretary).

The secretary/assistant (SEC) group has for general requirements (422):
access a unique and restricted user area;
edit profile information.

For dental treatment (423), there are the following requirements:
manage the dentist's calendar (appointment scheduling);
answer questions from patients (administrative, financial, etc.);
send a message to the dentist;
financial control of the patients' dental treatment (expenses, revenues, cash flow, etc.).

In the dentist (D1) group, in account management (424), the following requirements are provided:
access a unique and restricted user area;
manage master records with personal information (create, read, update, and remove) via the application, such as: first and last name, e-mail, password, photo, phone and business address, CRO/CRM, among others;
Register via Facebook or other social network;
change the system interface theme (background color/background image);
assign access and control permissions to the secretary/assistant.

In patient (425) control the following requirements are provided:
view the volume of patient accesses to the application and the treatment;
answer questions from patients.

In the orthodontic treatment (426) table, the following requirements are observed:
receiving and analyzing questionnaires and satisfaction surveys for treatments;
(R&D) receive suggestions for treatments plans for new patients;
(R&D) receive alerts about treatment plans for new patients.
receive pain and discomfort alerts during the use of the dental device;
receive questionnaires filled by patients regarding pain and oral discomfort;
change which microvibrators are used (frontal and lateral), according to the protocol;
change the microvibrator vibration frequency according to a specific protocol for each treatment stage (according to the protocol);
view smile images that were taken by the patient (personal marketing);
present the date (calendar) of the next appointment by the patients;
share treatment information with other dentists.

In administrator (ADM) group, in the general (427) item, the following requirements are provided:
control users (patients, dentists and secretaries);
answer to questions by users;
manage advertisement space.

In the system (428) group, control (428B) and diagnosis and prognosis (428C) items are provided.

Control (428B) has the following requirements:
enable a user activity log within the system;
perform encryption and authentication processes in all information traffic (transient data);
receive user errors (“bugs”) from the system in use;
include software watermark in photos and reports.

In the diagnosis and prognosis (428C) item, the following requirements are provided:
receiving and managing dental treatment data for all patients and dentists within a specified period (i.e., every 20 days);
running computational models of dentist and patient data;
sending decision making to users.

The interactive system itself is fairly broad and can deal with a variety of situations that include not only information related to the dental treatment, on a system level, dentist (D1) and patient (P), but also other forms of entertainment, with the flows in IMGs. 19-47 indicating and recording possible situations in the embodiment illustrated herein, but also based on the association between the device itself and the flowchart in FIG. 6. Therefore, other possible achievements do not flee the scope of this invention.

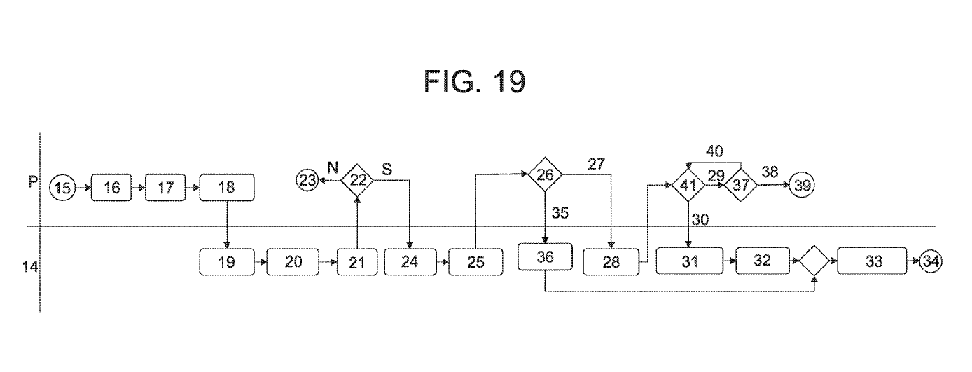

The flowchart in FIG. 19 shows the implementation of the treatment, with groups for the system (14B) and for the patient (P), the latter promoting its start (15) upon access to the process application (16), in which he is taken to the treatment group (17) and from there to the “Start treatment” (18) button, which seeks the treatment protocol (19), passing the burden to the care protocol (20) and displaying the starting message (21). If the answer is “no” (22), the process is terminated (23); if the answer is “yes” (24), the device (AP) is activated. To this end, there is a recording block for treatment data (25), which inquires about “pausing” (26) and, if positive (27), triggers a block that interrupts the activation of the device (28), which will again ask if it should “continue” (29); if the answer is “yes”(30), a device function relationship block (31) is triggered, which connects to the treatment data recording block (32) and which leads to the device functioning interruption block (33), followed by an “end” (34) indicator. If the question “pause” (26) has an answer of “no” (35), the continue device operation block (36) is activated, which in turn connects itself directly to the device functioning interruption block (33). If the answer to (30) is “no”, the “stop treatment?” question shows up. (37) which, if “yes” (38), takes to the “end” (39) command; if the answer to this question is “no” (40), the question “continue?” (41) is made once (41).

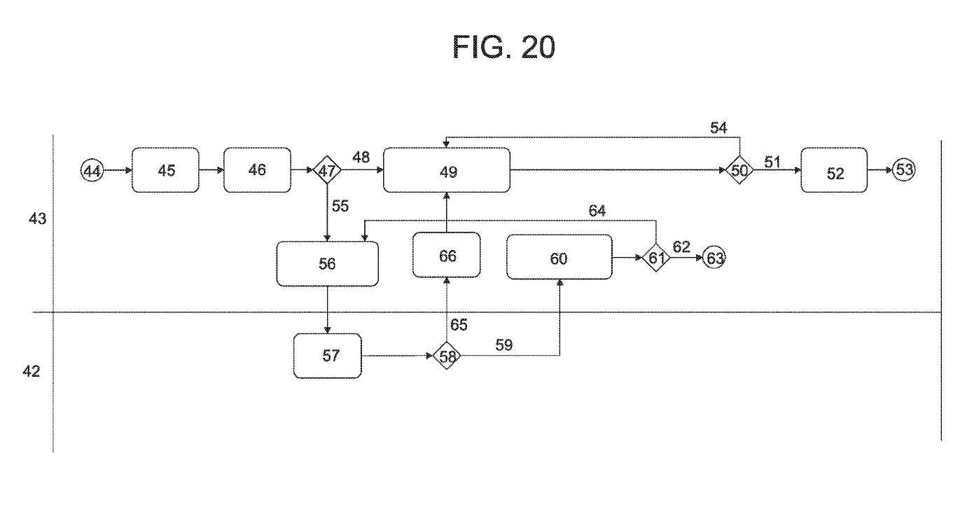

FIG. 20 illustrates a sponsored ad space flow, with banners for the system (42) and for the manager (43); with “start” (44) being enabled (of course, by the administrator), access to the process application is promoted (45), triggering the banner listings access block (46), which raises the question “register new ad?” (47). If the answer is “yes” (48), this triggers the ad information insertion block (49) (for example, photos, text and other images), connecting in sequence the question “ad ok?” (50). If the answer is “yes” (51), the ad is published (52) and the system is closed (53); if the answer is “no” (54), the system returns to the ad information insertion block (49). If in “register new ad?” (47) the answer is “no” (55), the active sponsors search block (56) is triggered, and from there the search execution block (57) will ask if there were any “results found?” (58) and, if the answer is “no” (59), the “ad not found” message (60) is shown, which asks if a new search should be carried out (61) and, if the answer is “no” (62), this is terminated (63); is the answer is “yes” (64), it returns to the active advertisers search block (56); if in (58) the answer is “yes” (65), it triggers the ad selection block (66), which connects to the ad information insertion block (49).

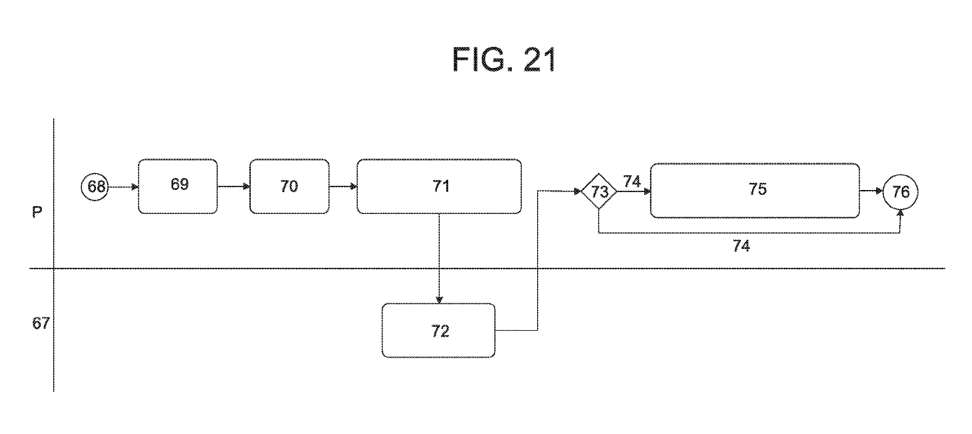

FIG. 21 illustrates an information access flow, with groups for the system (67) and the patient (P), with its start (68) marked by accessing the process application (69), going to treatment group block (70), which triggers the “triggers the button for accessing information about the continuous treatment” (71), after which the system displays treatment formations (72), which raises the question “Want to share on Facebook or another social network?” (73); if the answer is “yes” (74), this triggers the “posts continuous treatment information on Facebook, using the patient account” block (75) and, subsequently, closing (76) the system; if in (73) the answer is “no” (74), the system is forwarded directly to its termination (76).

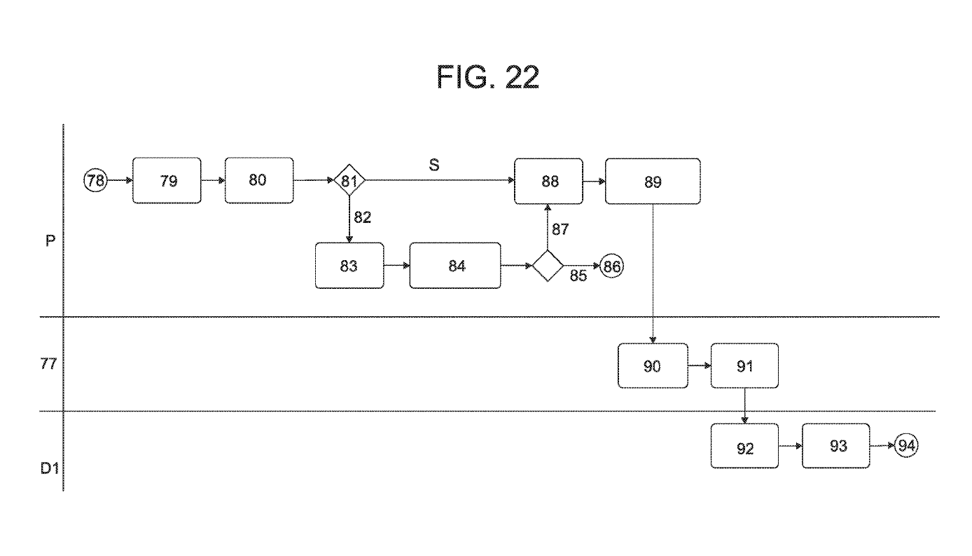

FIG. 22 exemplifies a message exchange flow with the dentist, with groups for the dentist (D1), system (77) and patient (P); to start (78), the patient (P1) accesses the process application (79) and then the message group (80), which asks “New message?” (81) and, if the answer is “no” (82), the message selection block (83) is triggered and the moves to the “read the message?” block (84); if “no” (85) is the answer, the process is terminated (86); however, if the answer is “yes” (87), the message writing block (88) is triggered, and from this block, the send message button (89) can be activated. From this, the recording block (9) of the message which is sent to the dentist (91) is activated; the dentist (D1) selects the message (92) and reads it (93) to finish (94) the process.

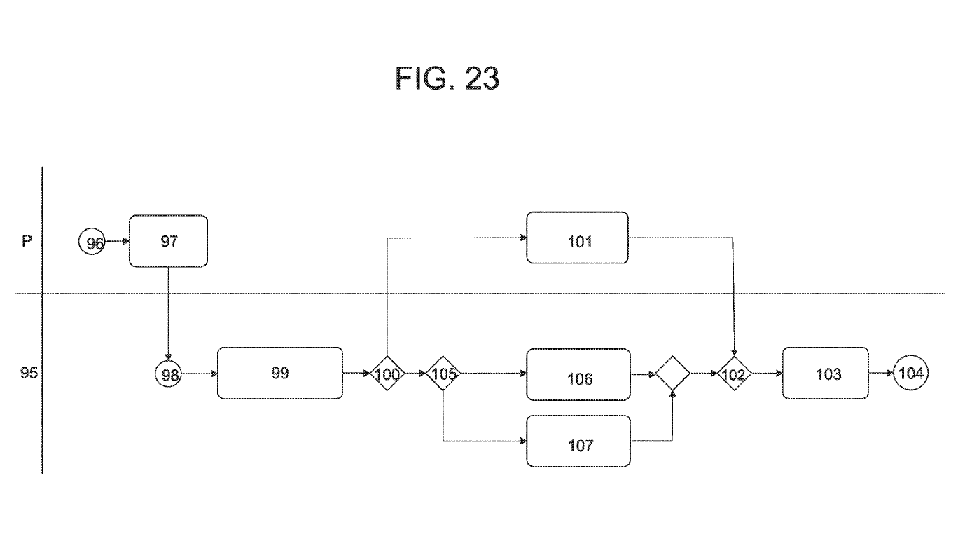

FIG. 23 exemplifies a continuous treatment questionnaires flow, with groups for the system (95) and the patient (P). This is started (96) when accessing the process application (97), while the system, every two months (98), displays a continuous treatment questionnaire (99), a block which operates a parallel (divergent) gate (100) which answers the questionnaire (101) and operates the parallel (convergent) gate (102) to record information (103) and terminate (104) the process. Parallel (divergent) port (100) asks if “Are there photos recorded by the patient between 21 and 30 days?” (105). With “yes” (106) or “no” (107) as answers, messages go to the parallel (convergent) gate (102), going through, as mentioned before, by recording (103) and termination (104).

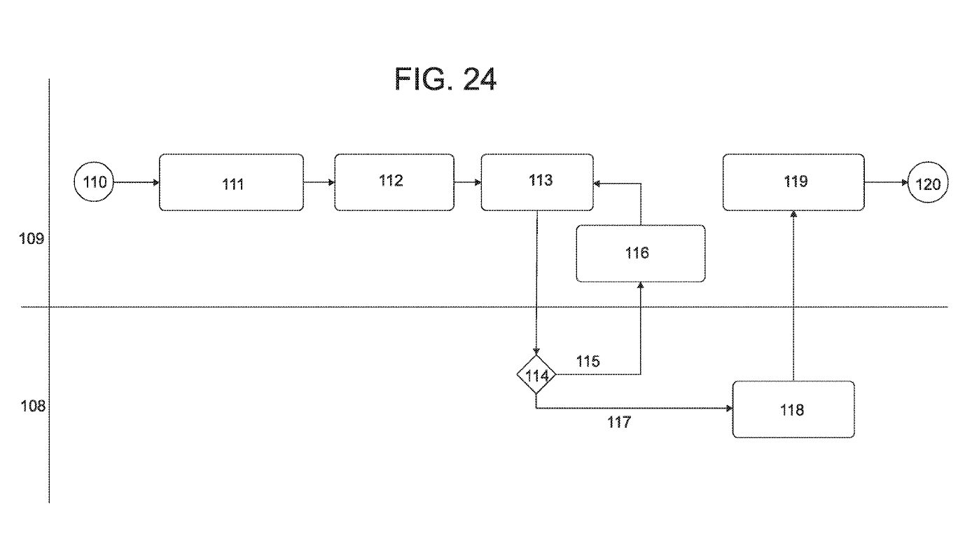

FIG. 24 illustrates a dentist record flow, with a group for the system (108) and another for the administrator (109). Its start (110) happens with an access to the administrative area of the process software (111) and then to providing access to the dentist record group (112), which triggers the dentist information entry block (113), which leads to the question by the “Mandatory information filled?” block (114). If the answer is “no” (115), the mandatory completion message block (116) is shown, which is then connected to the dentist information insertion block (113); if the answer is “yes” (117), the database information recording block (118) is triggered, which activates the dentist successfully registered message block (119) and then terminates (120).

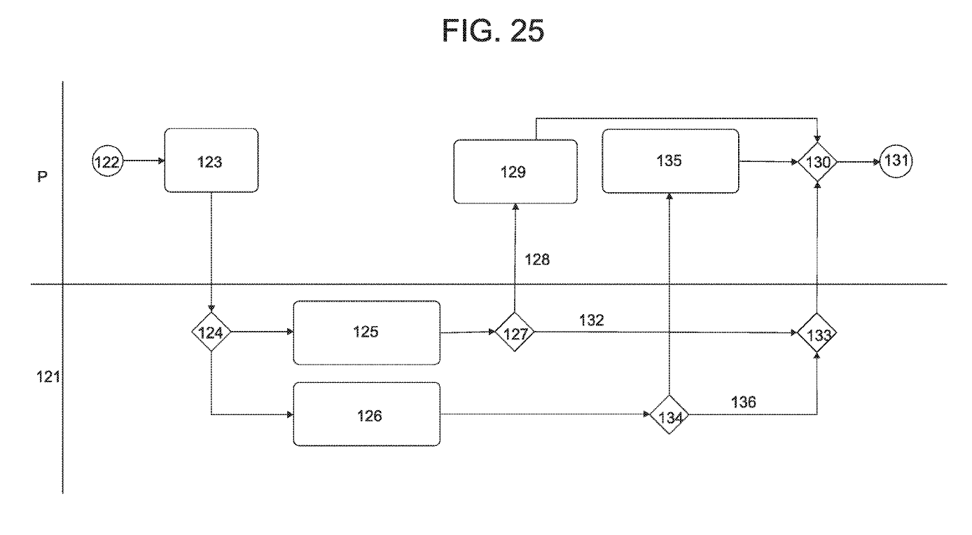

FIG. 25 exemplifies a process battery life warning flow, with a group for the system (121) and another for the patient (P). This starts (122) through accessing the process application (123), which communicates with a parallel (diverging) gate (124) and which, via the block (125), verifies the mobile phone autonomy and, via the block (126), verifies the system autonomy. Block (125) asks “critical battery” (127) and, if the answer is “yes” (128), block (129) promotes a low phone battery warning, sending this information to the parallel (convergent) gate (130) which ends the process (131); if the answer is “no” (132), the message is sent to the gate (133), which transfers it to a parallel (convergent) gate (130) which ends the process (131). Block (126) asks “critical battery” (134) and, if the answer is “yes” (135), the low phone battery warning block (135) is triggered as well as the parallel (convergent) gate (130), which ends the process (136); if the answer is “no” (136), this triggers gate (133), which connects to the parallel (convergent) gate (130) which ends the process (131).

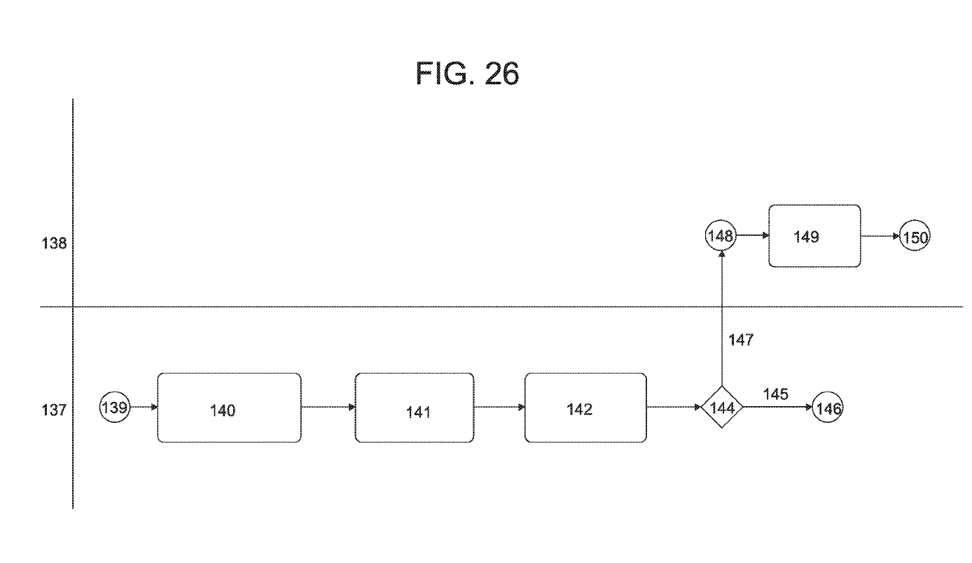

FIG. 26 illustrates a R&D flow-Receive treatment diagnosis and prognosis, with a group for the system (137) and another for the patient's application process (138). The system starts this process through a timer (139), triggering the patient treatment data selection block (140) and going through the computational model execution block (141) while block (142) stores results in the database (143) and prompts “Is there a warning to be sent?” (144); if the answer is “no” (145), the process is terminated (146); if the answer is “yes” (147), a warning is sent to the patient regarding the treatment status (148), which is verified through block (149) and then completed (150).

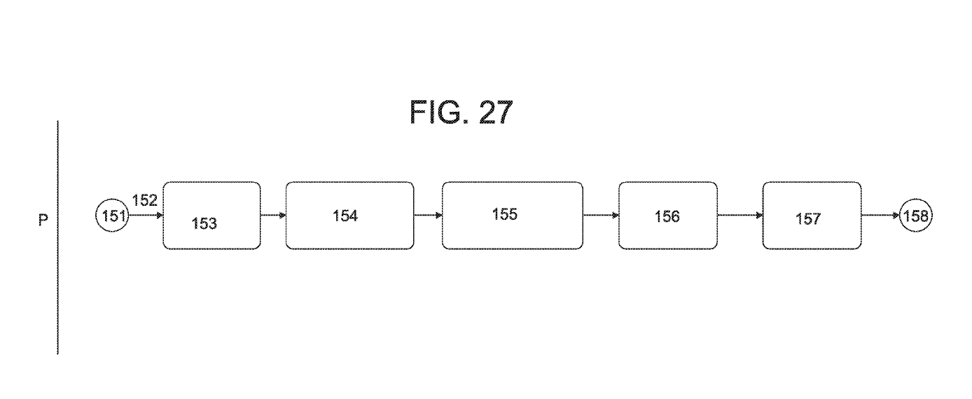

FIG. 27 exemplifies a flow that allows users to access games in the entertainment section. There is a group for the patient (P) which promotes its start (151), accessing the system application (152), which leads to the games block (153) which, through the block (154), displays a list of available games (155), in which the user selects the desired game (156) so the block (157) can run the game until its termination (158).

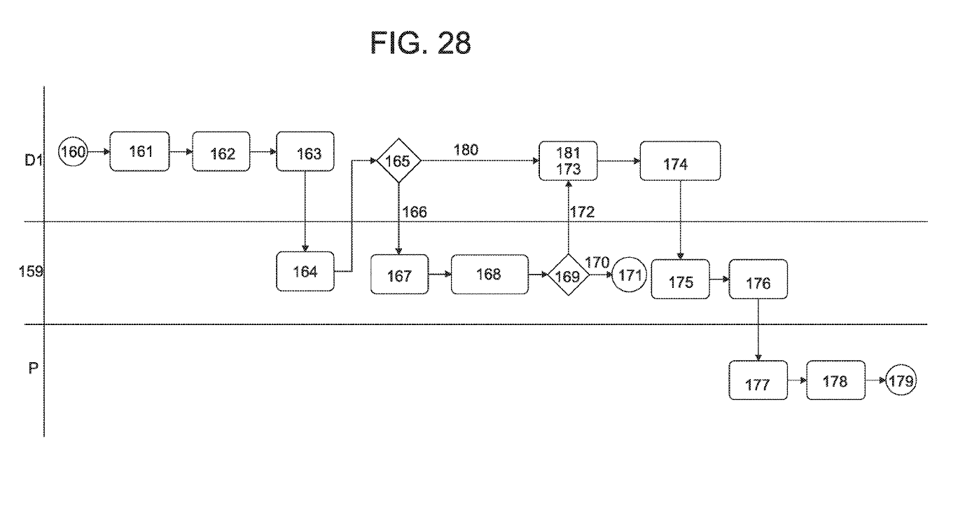

FIG. 28 exemplifies message exchange flow with patients, which contains a group for the system (159), one for the dentist (D1) and another for the patient (P), with the dentist (D1) starting it (160) and then through to the application block (161), to the block that displays the messages banner (162), followed by the patient selection block (163) and the block (164) that displays messages from the patient. Following this, the “New message?” inquiry is made (165); if the answer is “no” (166), the message in block (167) is selected, while block (168) reads the message followed by an “Answer message?” inquiry (169) and, if the answer is “no” (170), completion (171) occurs. If the answer is “yes” (172), block (173) promotes the writing of the message, followed by pressing the send message button (174), which records the message (175) and sends this message to the patient (176), which selects the message (177), reads it (178) and terminates the process (179). If in (165) the answer is “yes” (180), the write message block (181) follows, after which the same sequence in (174) is followed—in other words, triggering the send message button.

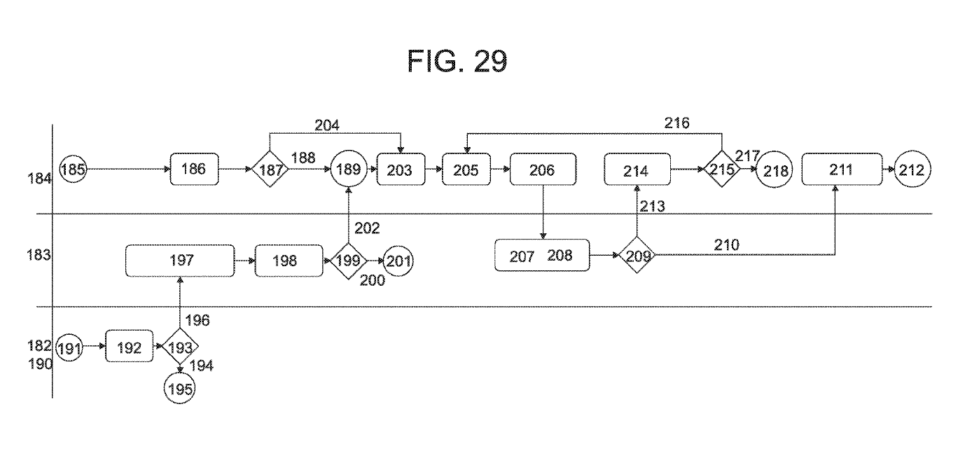

FIG. 29 exemplifies an oral health monitoring flow for patients, exhibiting a group for the patient's application (182), another for the system (183) and one for the patient (184).

The patient starts it in (185), with an access to the application (186), which is followed by “Is there any alerts regarding the patient's oral health?” (187) and, if the answer is “yes” (188), an alert is sent to the dentist (189). However, the application (182) has in (190) the treatment length application (191), which, via (192), connects to the Internet through the question “Is there Internet access?” (193). If the answer is “no” (194), it is terminated (195); if the answer is “yes” (196), then follows the block for recording oral health information in the system database (197), so that block (198) can compare oral health information and follow with the question “Standards normal?” (199) and if the answer is “yes” (200), completion (201) occurs; if the answer is “no” (202), an alert for the dentist (189) is triggered, from which the block that accesses patient listings (203) is activated, something that is also operated from the “no” response (204) in (187). Following this, the patient selection block (205) is triggered and then to the oral health monitoring selection block (206) that triggers block (207) to search for information regarding the patient's oral health (208), followed by the question “Information available?” (209), and, if the answer is “yes” (210), the block that displays information regarding the selected patient's oral health (211) is activated, followed by termination (212); if the answer is “no” (213), the block that displays unavailable information messages is triggered (214), followed by the question “Select another patient?” (215); if the answer is “yes” (216), then it returns to the patient selection (205); if “no” (217) is the answer, termination occurs (218).

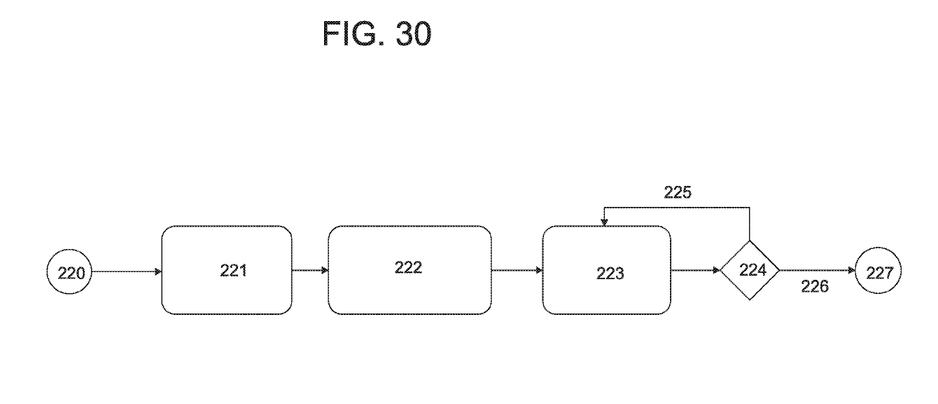

FIG. 30 exemplifies a system app interface customization flow, which, when initialized (220), enables access to the system application (221), followed by access to the customization group (222) and then to the interface theme modification block (223), succeeded by the question “Do you want to save this new configuration?” (224); if the answer is “no” (225), it goes back to the interface theme modification block (223); if the answer is “yes” (226), it is terminated (227).

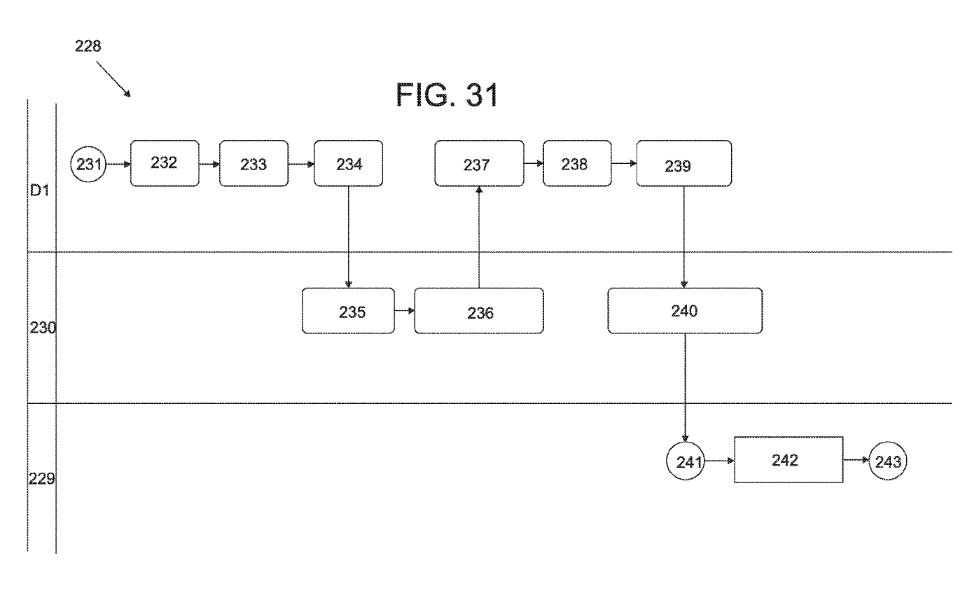

FIG. 31 exemplifies a patient protocol change flow (228), with groups for the system application—patient—(229), one for the system (230) and another for the dentist (D1). The dentist promotes its start (231) by activating the block that accesses the system application (232), which activates the access to the patient listings (233), followed by patient selection block (234), which communicates with the computational model execution block (235) and this with the block that shows suggestions of treatment and pain protocols (236), which then follows to the treatment protocol selection block (237), which in turn triggers the pain protocol selection block (238) followed by the protocol modification conformation block (239). After this is done, the block for updating selected protocols in patient records in the database (240) is triggered, which directs access to the application (241), followed by the block that updates patient protocols (242) and then to termination (243).

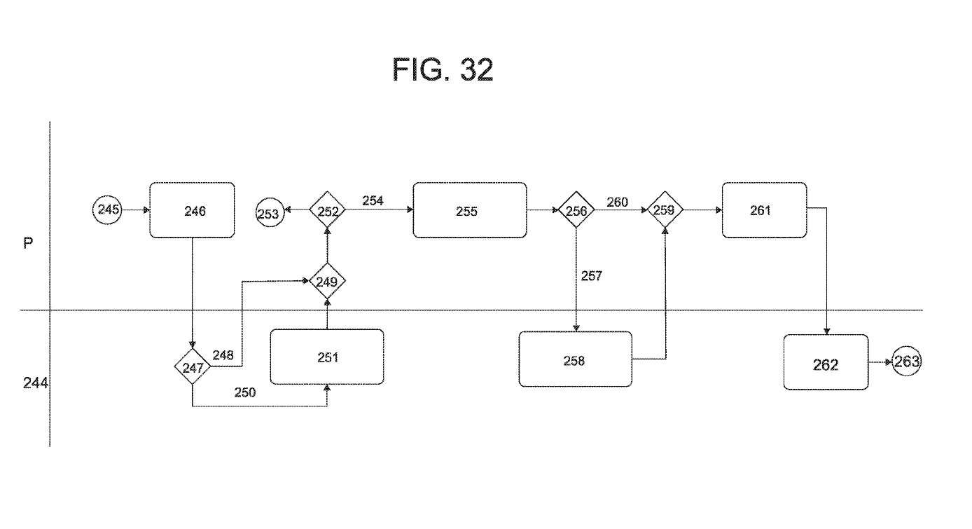

FIG. 32 illustrates a picture-taking flow for monitoring treatment, with groups for both the system (244) and the patient (P). The patient starts the flow (245) triggering the system application block (246) that inquires “Has it been 21/30 days since the last picture?” (247); if the answer is “no” (248) the flow proceeds to the convergent gate (249), and if the answer is “yes” (250) the flow triggers the block that displays a warning message indicating to take a picture (251), which proceeds to the convergent gate (249) that inquires “Take picture now?” (252); if the answer is “no”, the flow ends (253), and if the answer is “yes” (254) the flows proceeds to the picture-taking group (255), then it inquires “Do you want to receive guidance on how to take the picture?” (256); if the answer is “yes” (257) the flow triggers the block that shows guidelines on how to take a picture (258) and proceeds to the convergent gate (259), and if the answer is “no” (260) the flow proceeds to the convergent gate (259), then to the picture-taking block (261), followed by picture-recording (262) and completion (263) blocks.

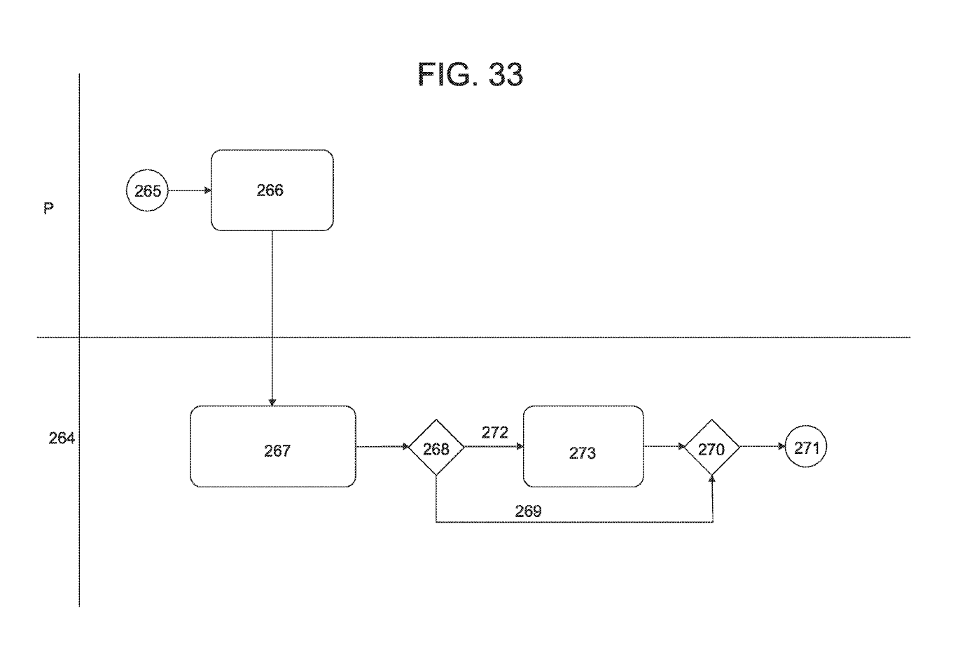

FIG. 33 illustrates a Alert Flow for the next dentist appointment, with a group for the system (264) and another to the patient (P), who starts the flow (265) followed by access to the system application (266), and through block (267) the flow checks the agenda of the next appointment, then inquires “Alert required? 20, 15, and 1 day(s) before?” (268); if the answer is “no” (269) the flow proceeds to the convergent gate (270) and completion block (271); if the answer is “yes” (272) the flow triggers the display of an alert to the patient (273).

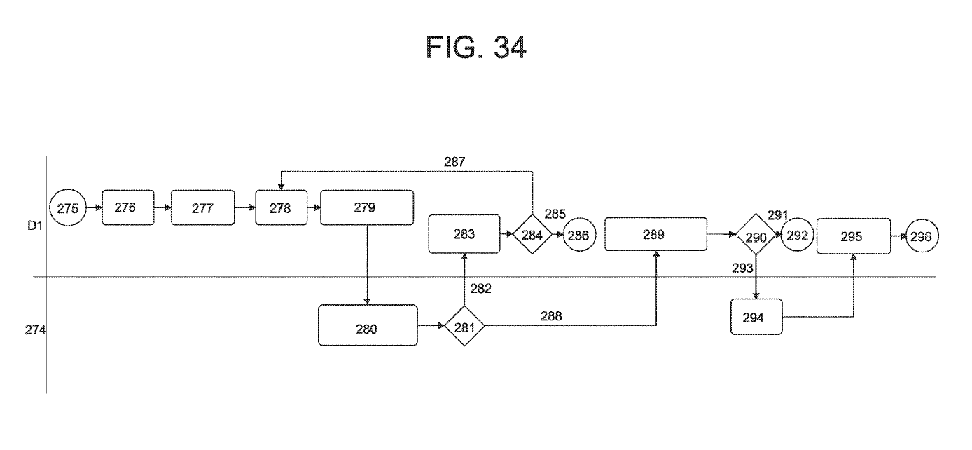

FIG. 34 illustrates a Flow of access to information on continuous treatment, with groups for both the system (274) and the dentist (D1). The flow starting (275) is triggered by the dentist, who calls the system application access block (276), followed by the selection of the patient's group (277) and patient selection (278), which triggers the block of selection of information on continuous treatment (279), which triggers the block to search information on continuous treatment for the selected patient (280), which inquires “Is there information available?” (281); if the answer is “no” (282) the flow triggers the block to show the message of unavailable information (283), which inquires “Select another patient?” (284); if the answer is “no” (285) the flow proceeds to the completion block (286), and if the answer is “yes” (287) the flow returns to the Patient Selection block (278). If in block (281) the answer is “yes” (288), the flow triggers the block that displays information on the continuous treatment of the selected patient (289), which leads to the inquiry “Do you want to print report?” (290) and, if the answer is “no” (291) the flow proceeds to the completion block (292); if the answer is “yes” (293) the flow triggers the report generation block (294) then the report download (295) and completion (296) blocks.

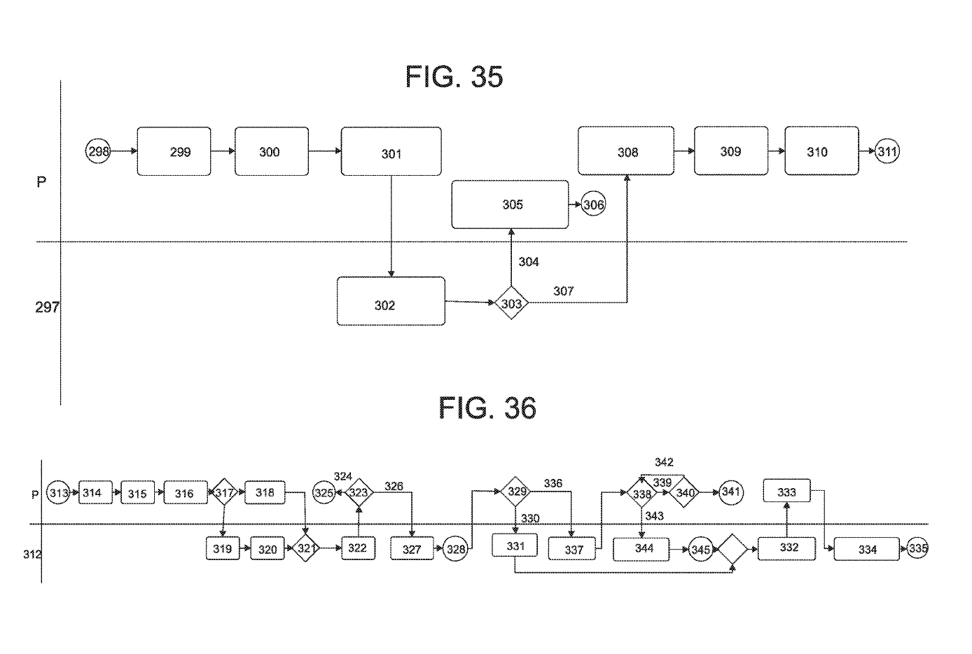

FIG. 35 illustrates a flow of visualization of the pictures of the patients' smiles, with a group for the system (297) and another for the patient (P), who starts (298) and accesses the system application (299), and the snapshot group (300), followed by the selection of the desired patient (301) to look for the pictures of such patient (302) in the system, when emerges the inquiry “Is there any picture?” (303) and if the answer is “no” (304), the flow proceeds to the block that displays the “photos not found” message (305), followed by the completion block (306); if the answer is “yes” (307), the flow accesses the block that displays the list of available photos of the selected patient (308), then occurs the selection of the desired photo (309), display of the photo (310) and flow completion (311).

FIG. 36 illustrates a flow of execution of the treatment of pain, with a group for the system (312) and another for the patient (P), who starts the flow (313), with access to the system application (314), leading to the group of pain treatment (315), directing to block of activation of the pain relief button (316), followed by the parallel gate (317), which on one hand triggers the block of responses to pain questioning (318), and on the other hand accesses the block of pain protocol search (319), followed by the block of pain protocol loading (320), reaching the other parallel gate (321), where also come the answers to the pain questioning, know as parallel gate (321), triggering the block of message display (322) that inquires “Start?” (323), if the answer is “no” (324) the flow proceeds to completion (325) and if the answer is “yes” (326) the block of activation of the device (327) is triggered, and the execution time (328), which communicates with the “Pause?” gate (329), if the answer is “no” (330) the flow proceeds to the block of continuation of the device operation (331), which leads to a gate of the block of device operation completion (332) that triggers the block of responses to the post-pain questionnaire (333), which, in turn, leads to the block that records and sends the questionnaire data to the dentist (334) and to completion (335). If in (329) the answer is “yes” (336), the device interruption block is triggered (337) and the “Continue?” inquiry is made. (338), if the answer is “no” (339), the device is interrupted (340) and terminated (341), still with the possibility of questioning on whether or not to continue (342); if the answer is “yes” (343) the flow triggers the device operation reactivation block (344), which keeps a running time (345) and goes to the block (332), following the same protocol previously described.

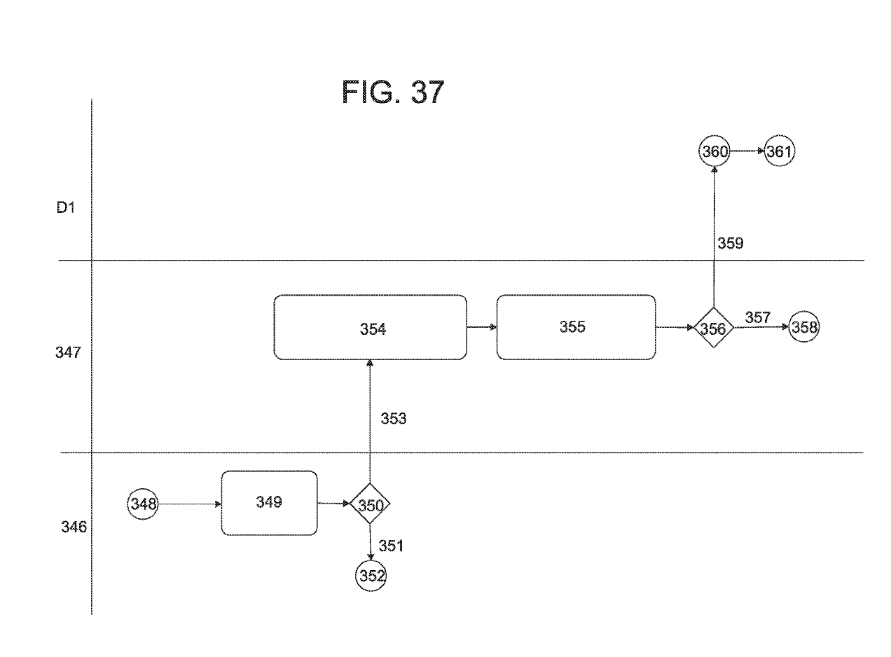

FIG. 37 illustrates a flow of malfunction of device sensors and micro-vibrators in use, with a group for the application of the device of the patient (346), one for the system (347) and another for the dentist (D1). The start (348) leads to the internet connection block (349), with the question “Does it have internet access?” (350), if the answer is “no” (351) completion occurs (352); if the answer is “yes” (353) the flow triggers the block (354), which records the status information of the device sensors and, through block (355), compares the information on the device sensors leading to the “Normal patterns?” inquiry. (356), if the answer is “yes” (357) the process is terminated (358), and if the answer is “no” (359) an alert is sent to the dentist (360) and the flow ends (361).

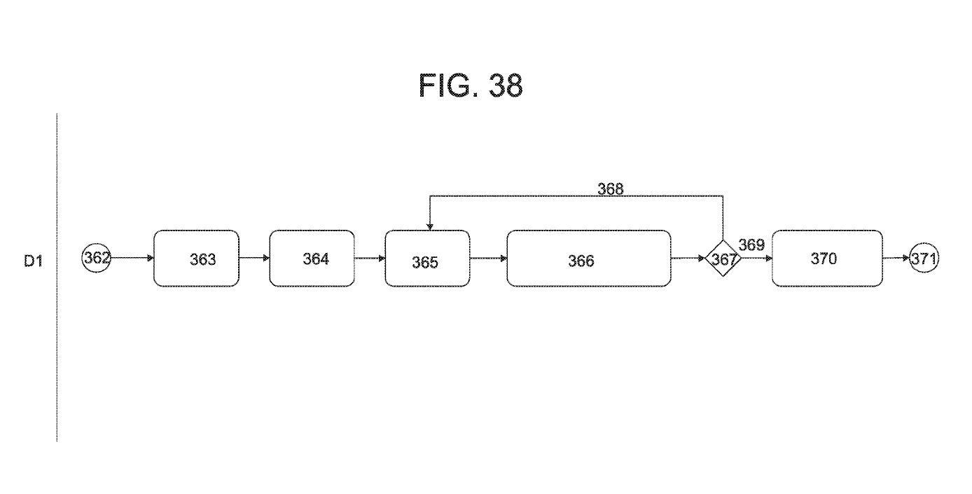

FIG. 38 illustrates a flow to enable and disable the exchange of messages with the patient, with a group to the dentist (D1), who starts the flow (362), with access to the system application (363), followed by access to the group of patients (364) and select of the desired patient (365), followed by the block that disables/enables the exchange of messages with the selected patient (366) with the question “Do you want to select another patient?” (367), if the answer is “yes” (368) the flow goes back to block (365), and if the answer is “no” (369) the flow proceeds to the configuration save block (370) and terminates the process (371).

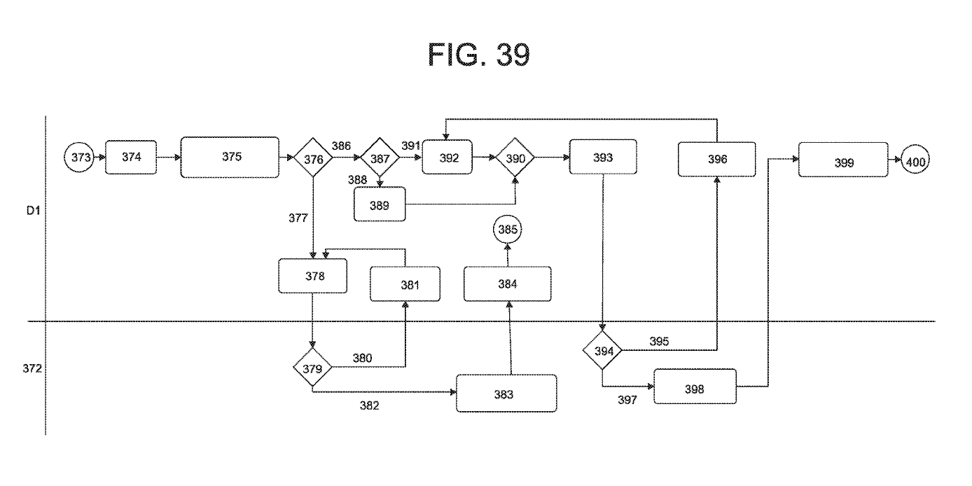

FIG. 39 illustrates a flow of association and dissociation of patients, with a group for the system (372) and another for the dentist (D1), who starts the process (373) with access to the application (374), which, in turn, accesses the group association and dissociation of appliances/patients (375) with the question “Associate or dissociate?” (376); if the answer is dissociation (377), the block (378) searches in the device's N/S with the question “Device's N/S found?” (379), if the answer is “no” (380) the block (381) displays the message “Device's N/S not found” and returns to block (378); if the answer is “yes” (382) the flow triggers the block that updates the patient record by removing the N/S of the device (383), and through block (384) displays the message “Dissociation successfully completed” and terminates the process (385). If the answer in (376) is “association” (386), it follows the question “Patient already registered?” (387), if the answer is “no” (388), the patient registration (389) is made and the command is sent to the convergent gate (390); if the answer is “yes” (391) the patient is selected (392) and the command is sent to the convergent gate (390), from which the insertion block of the device's N/S (393) is triggered, followed by the question “N/S available?” (394); if the answer is “no” (395) the flow triggers the block (396) that displays the message “N/S already in use by another patient,” returning to the patients selection block (392); if the answer is “yes” (397), the flow proceeds to the block that updates the patient record with the device's N/S (398), followed by the block that displays the message “Association successfully completed” (399), then the process is terminated (400).

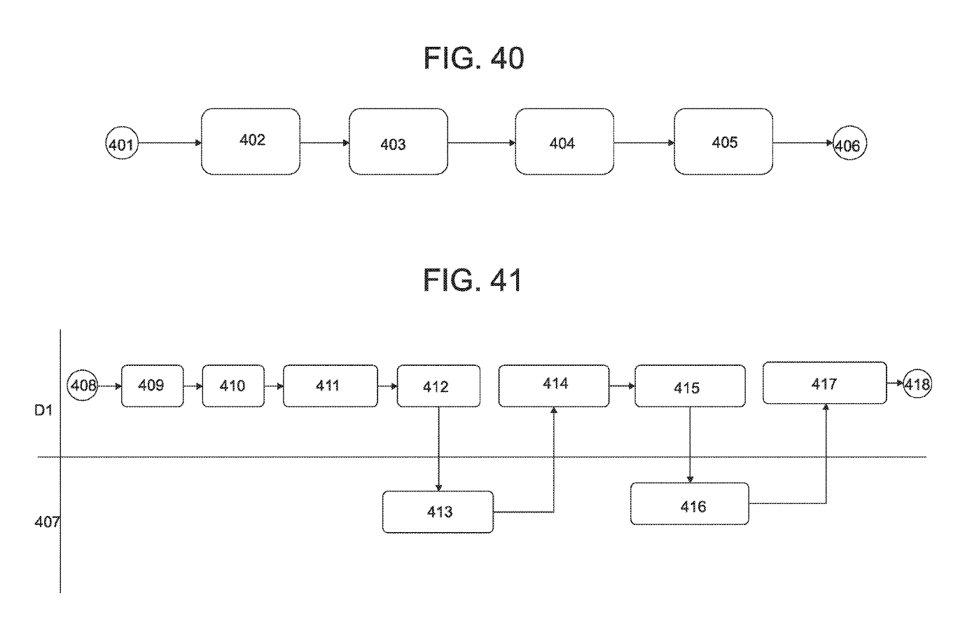

FIG. 40 illustrates a flow of patient registration, with start (401), access to the system application (402), access to the patient group (403), inclusion of patient data (404), recording of data in the system (405) and completion (406).

FIG. 41 illustrates a Flow of access to the questionnaires completed by patients, with a group for the system (407) and another for the dentist (D1), with flow start (408), access to the application (409), access to the patient's group (410), selection of the desired patient (411), selection of the questionnaire option (412), search for the selected patient's questionnaires (413), which triggers the block that displays a list of questionnaires found (414), followed by the block of selection of the desired questionnaire (415), followed by the block that carries the information regarding the selected questionnaire (416), leading to the block that displays the selected questionnaire information (417), then ends the process (418).

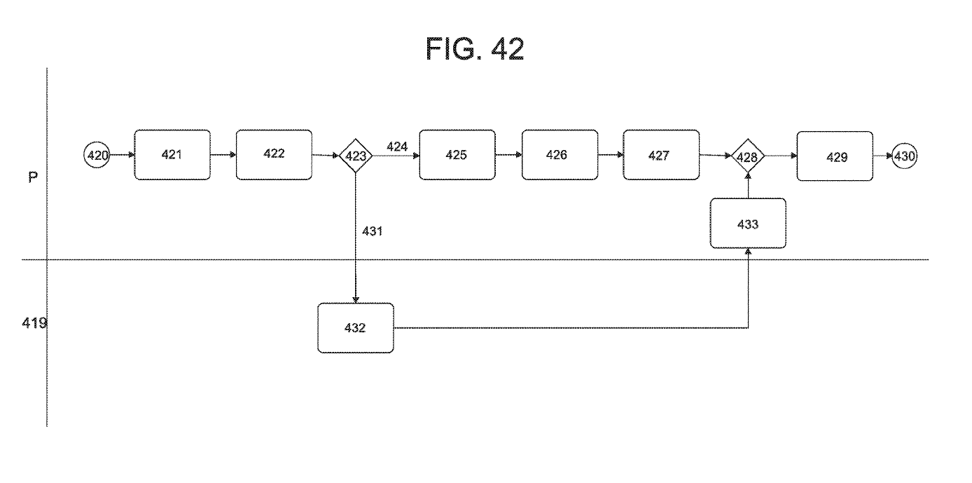

FIG. 42 illustrates a Flow of entertainment that lets you listen to music and manage playlists, with a group for the system (419) and another for the patient (P), who starts the flow (420) by accessing the system application (421) and the music group (422), followed by the question “Dou you want to create playlists?” (423); if the answer is “yes” (424) the block (425) creates a new playlist, while the block (426) generates the selection of music, the block (427) saves the playlist, proceeding to the convergent gate (428), where the command to run the playlist (429) is generated, and the process is terminated (430); if the answer in (423) is “no” (431) the flow displays the list of existing playlists (432) that communicates with the selection block of the desired playlist (433), which, through the guidance by the convergent gate (428), access the block to run the playlist (429).

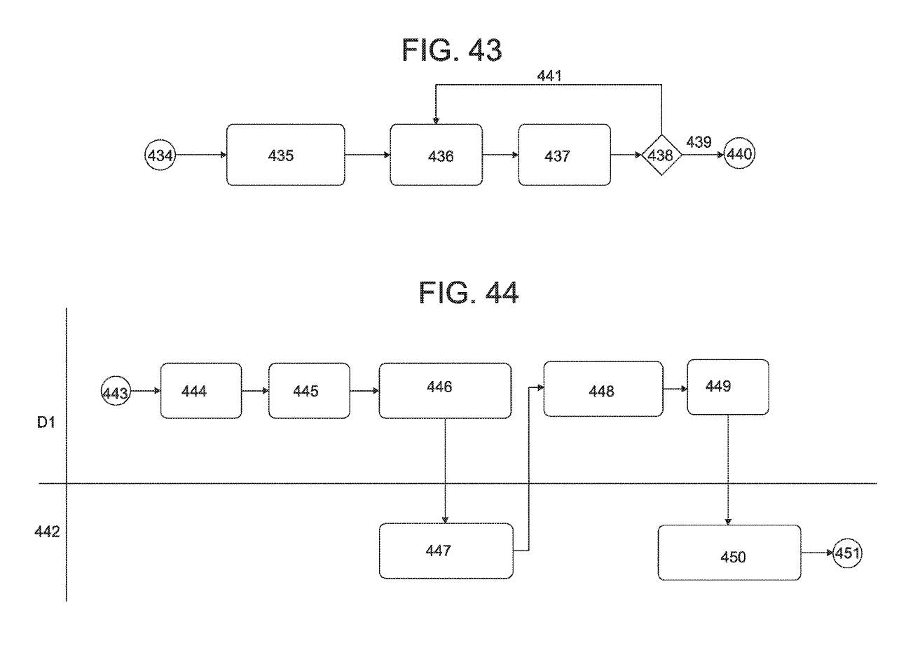

FIG. 43 illustrates a flow of music selection, whose starting (434) leads to the music library (435), followed by the selection of songs (436), block (437) that adds songs to the playlist, followed by the question “Do you want to add more songs?” (438); if the answer is “no” (439) the process ends (440); if the answer is “yes” (441) the flow returns to the Music Selection block (436).

FIG. 44 illustrates a flow for scheduling patient visits, with a group for the system (442) and another for the dentist (D1), who starts the flow (443) accessing the system application (444), the schedule group (445), which leads to the block of selection of the scheduling unit available (446), which triggers the block that searches for registered patients (447) and the block that displays the list of registered patients (448), from which follows the block of selection of the desired patient (449), which communicates with the block that shows the association of the selected patient with the selected scheduling unit (450), then ends the process (451). For clarification, scheduling unit refers to an object composed of a date (day, month, and year) and time (hour and minute).

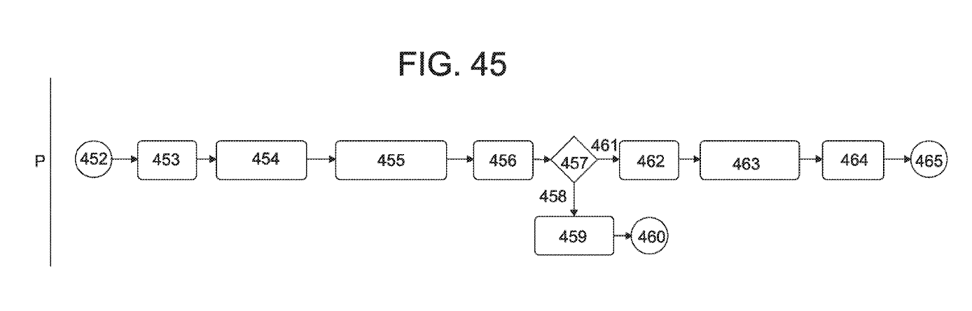

FIG. 45 illustrates a flow of connection with the patient's device, with group for the patient (P), who starts the flow (452), at which time the block (453) powers the device on (454) and enables system access to the application (455), and accesses the group of bluetooth/wireless, that triggers the device search block (456), followed by the question “Device found?” (457), if the answer is “no” (458) the message of “device not found” (459) is made available, and the process is terminated (460). If the answer is “yes” (461), the flow proceeds to the device selection block (462), followed by the block of connection between the device and the application (463) and the block of “connected device” message (464), then ends the process (465).

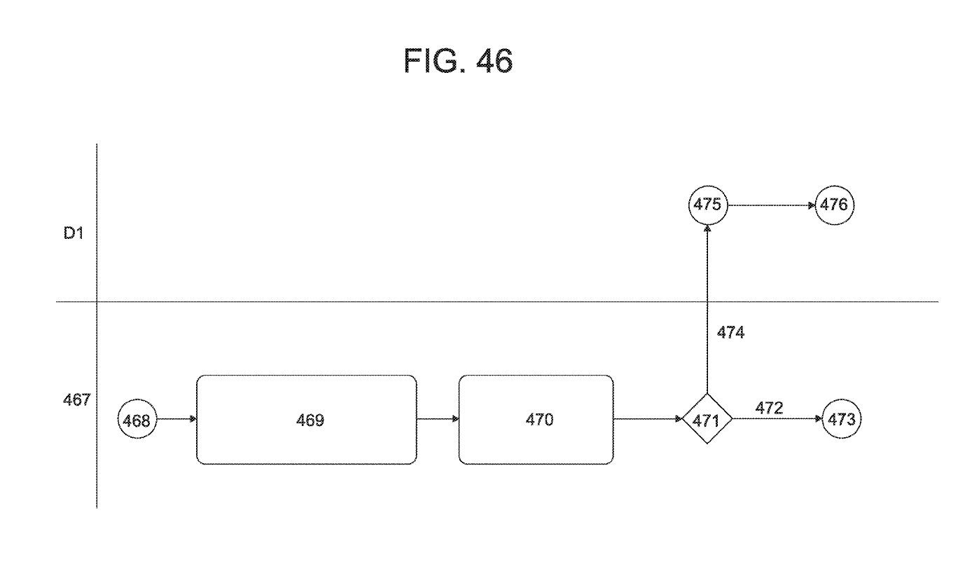

FIG. 46 illustrates a flow of R&D that receives alerts on the treatment of active patients, with a group for the system (467) and another for the system application of the dentist (D1); the system starts (468) by a timer that triggers the execution of the block of execution of the computational model for all active patients (469), proceeding to the block that stores the results in the database (470), when the question “Is there any alert to be sent?” emerges. (471); if the answer is “no” (472) the process ends (473); if the answer is “yes” (474) an alert is sent to the dentist about the statuses of the treatments (475) to the completion of the process (476).

What is claimed is:

1: Intraoral Vibratory Multifunctional Device, consisting of a dental device with vibration features through vibration means and an element that fixes it to the dental arch or to an orthodontic appliance, which is integrated to a system for interactions between patient (P) and dentist (D1); the said device making use of software (S) and hardware (H) for both the patient and the dentist, wherein the device (AP) is composed by microvibrators (1) and a vibration strap; (2) and also including parameter sensors (S1) for the patient's oral region.

2: Intraoral Vibratory Multifunctional Device, according to claim 1, wherein the device (AP) receives the connection of accessory devices to the vibration strap (2), including bite plates (PM) on a first embodiment and securing clips (3A) on a second embodiment.

3: Intraoral Vibratory Multifunctional Device, according to claim 2, wherein microvibrators (1) are at least three—one frontal and two laterals or posterior.

4: Intraoral Vibratory Multifunctional Device, according to claim 1, wherein, in the version in which bite plates (PM) are used, as patients with lingual orthodontic appliances and dental aligners, clips (3) are used to secure these components to the vibration strap (2).

5: Intraoral Vibratory Multifunctional Device, according to claim 2, wherein the securing clip (3A) is used on patients using conventional orthodontic appliances.

6: Intraoral Vibratory Multifunctional Device, according to claim 4, wherein the clip design (3A) enables the adaptation of this clip (3A) to any type and caliber of orthodontic wire, particularly due to its internal drop-shaped design (G).

7: intraoral Vibratory Multifunctional Device, according to claim 6, wherein they are used as many clips (3A) as needed thr the adaptation of the vibrating device to the arch and that of the latter to the orthodontic appliance.

8: Intraoral Vibratory Multifunctional Device, according to claim 7, wherein the clips (3A) have an internal gap that ranges from 0.1 mm to 1.0 mm.

9: Intraoral Vibratory Multifunctional Device, according to claim 4, wherein the posterior bite plate (PM) has at least three securing clips (3) attached to its side edge and associated to the thermoplastic bite plate (PM) structure, this bite plate (PM) having a variable thickness and being thinners in its posterior part than in its front part.

10: Intraoral Vibratory Multifunctional Device, according to claim 1, wherein there are sensors (S1) applied to regions in the bite plate (PM) and/or in the outer rim (6) of the device (AP).

11: Intraoral Vibratory Multifunctional Device, according to claim 10, wherein sensors (S1) are selected among bite pressure sensors (S1′), oral temperature sensors (S1″), ketone bodies sensor (S1′″) and a pH sensor (S1″″).

12: Intraoral Vibratory Multifunctional Device, according to claim 1, wherein the front of the device (AP) has a receptacle (5) attached to the appliance (AP) outer rim (6), in which some operational components of the appliance are housed; this said housing (5) and the said outer m of the appliance (6) are made of a plastic material in which sensors (S1) are inserted in this outer rim of the appliance (6) and are distributed alongside microvibrators (1) for the collection of oral parameters; in this receptacle (5) are also housed the hardware for controlling vibrations and other sensors, the Bluetooth communication hardware, wireless, gyroscope and accelerometer, plus at least one battery (7), an electronic circuit (8), a LED indicator (9) and a reset button (10).

13: Intraoral Vibratory Multifunctional Device, according to claim 1, wherein the vibration frequency is, in a first form of treatment, between 40-60 Hz and, in a second form of treatment, between 100-120 Hz, with changes in frequency values being made through changes in protocols.

14: Wireless Device, Patient and Dentist Interaction System, for use in conjunction with the device in claim 13, which uses software (5) and hardware (H) for the patient and the dentist, as well as the Internet, with features such as wireless and Bluetooth, to send and receive database (BD) information about the process, establishing application environments, wherein comprises an interactive system that comprises a process flow chart including the patient (P) and the dentist (D1), the device (AP), the system administrator (ADM), the secretary/assistant (SEC), the process database (BD), in order to collect data and control various functions of the device, with pain and treatment protocols and communication between all parties.

15: Wireless Device, Patient and Dentist Interaction System, according to claim 14, wherein requirements for account management (417), dental device (418), orthodontic treatment (419), entertainment (420) and communication (421) are provided in the patient (P) group.

16: Wireless Device, Patient and Dentist Interaction System, according to claim 14, wherein general (422) and dental treatment (423) requirements are provided in the secretary/assistant group.

17: Wireless Device, Patient and Dentist Interaction System, according to claim 14, wherein requirements for account management (424), patient control (425) and orthodontic treatment (426) are provided in the dentist (D1) group.

18: Wireless Device, Patient and Dentist Interaction System, according to claim 14, wherein the general item (427) is provided in the administrator (ADM) group.

19: Wireless Device, Patient and Dentist Interaction System, according to claim 14, wherein the device (AP) is connected to the patient's (P) software (S1), with this software (S1) operating on the Internet (IT) and, via login/password (9), web services (10) carry information to the process database (BD).

20: Wireless Device, Patient and Dentist Interaction System, according to claim 14, wherein the dentist (D1) has a machine with a software (S2) that also operates on the Internet (IT) and, via login/password (913), web services (10B) carry information to the process database (BD).

21: Wireless Device, Patient and Dentist Interaction System, according to claim 14, wherein comprises an access system by the dentist (D1), through a computer (11) that operates on the Internet (IT) and the latter on the process web portal (12) and that, via login/password (9C), communicates with the dentist access restricted process web system (13), which exchanges information with the process database (BD), which is also reached by information originating from the patient (P) and the dentist (D1).

22: Wireless Device, Patient and Dentist Interaction System, according to claim 14, wherein comprises a system that acts on executing the treatment through a flow with groups for the system (14) and the patient (P).

23: Wireless Device, Patient and Dentist Interaction System, according to claim 14, wherein comprises a system that acts with sponsored ad spaces through a flow with groups for the system (42) and the administrator (43).

24: Wireless Device, Patient and Dentist Interaction System, according to claim 14, wherein the system acts on accessing information through a flow with groups tier the system (67) and the patient (P).

25: Wireless Device, Patient and Dentist Interaction System, according to claim 14, wherein the system acts on the exchange of messages with the dentist through a flow with groups for the dentist (D1), the system (77) and the patient (P).

26: Wireless Device, Patient and Dentist Interaction System, according to claim 14, wherein comprises a system that acts on executing the treatment through a flow with groups for the system (95) and the patient (P).

27: Wireless Device, Patient and Dentist Interaction System, according to claim 14, wherein the system acts as the dentist (D1) record through a flow with a group for the system (108) and another for the administrator (109).

28: Wireless Device, Patient and Dentist interaction System, according to claim 14, wherein the system acts on the process battery life warning, through a flow with one group for the system (121) and another for the patient (P).

29: Wireless Device, Patient and Dentist Interaction System, according to claim 14, wherein the system acts on the reception of treatment diagnosis and prognosis, through a flow with one group for the system (137) and another for the patient process application (138).

30: Wireless Device, Patient and Dentist Interaction System, according to claim 14, wherein, in the entertainment segment, the system acts on enabling the user to access games in its entertainment section, with a group for the patient (P).

31: Wireless Device, Patient and Dentist Interaction System, according to claim 14, wherein the system exchanges messages with patients (P), through a flow with a group for the system (159), another for the dentist (D1) and another for the patient (109).

32: Wireless Device, Patient and Dentist Interaction System, according to claim 14, wherein the system acts on the monitoring of patient oral health, through a flow with one group for the patient application (182), another for the system (183) and one for the patient (184).

33: Wireless Device, Patient and Dentist Interaction System, according to claim 14, wherein the system contains a system app interface customization flow.

34: Wireless Device, Patient and Dentist Interaction System, according to claim 14, wherein the system acts on changing patient protocols (228), through a flow with groups for the patient-system application (229), one for the system (230) and another for the dentist (D1).

35: Wireless Device, Patient and Dentist Interaction System, according to claim 14, wherein a system acts on obtaining treatment photos through a flow with groups for the system (244) and the patient (P).

36: Wireless Device, Patient and Dentist Interaction System, according to claim 1, wherein the system acts on an alert for the next appointment to the dentist, through a flow with one group for the system (264) and another for the patient (P).

37: Wireless Device, Patient and Dentist interaction System, according to claim 14, wherein the system acts on accessing continuous treatment information, through a flow with groups for the system (274) and the dentist (D1).

38: Wireless Device, Patient and Dentist Interaction System, according to claim 14, wherein the system acts on viewing photos from patient smiles, through a flow with one group for the system (297) and another for the patient (P).

39: Wireless Device, Patient and Dentist Interaction System, according to claim 14, wherein the system acts on executing pain treatment, through a flow with one group for the system (312) and another for the patient (P).

40: Wireless Device, Patient and Dentist Interaction System, according to claim 14, wherein the system acts on malfunctioning sensor on the device being used, through a flow with groups for the patient device application (346), one for the system (347) and another for the dentist (D1).

41: Wireless Device, Patient and Dentist Interaction System, according to claim 14, wherein the system acts on enabling and disabling the exchange of messages with the patient, through a flow with a group for the dentist (D1).

42: Wireless Device, Patient and Dentist interaction System, according to claim 14, Wherein the system acts on the association and disassociation of patients, through a flow with one group for the system (372) and another for the dentist (D1).

43: Wireless Device, Patient and Dentist Interaction System, according to claim 14, wherein the system acts on the registration of patients, through a flow with start (401) and access to the system application (402), to the patient group (403), to the insertion of patient data (404), recording system data (405) and conclusion (406).

44: Wireless Device, Patient and Dentist Interaction System, according to claim 14, wherein the system acts on the access to questionnaires answered by patients, through a flow with one group for the system (407) and another for the dentist (D1).

45: Wireless Device, Patient and Dentist Interaction System, according to claim. 14, wherein the system acts on aiming to provide a form of entertainment that allows listening to music and managing playlists, through a flow with one group for the system (419) and another for the patient (P).

46: Wireless Device, Patient and Dentist Interaction System, according to claim 14, wherein a system acts on enabling the selection of songs through a flow that leads to the music library (435).

47: Wireless Device, Patient and Dentist Interaction System, according to claim 14, wherein the system acts on creating patient appointments, through a flow that includes one group for the system (442) and another for the dentist (D1).

48: Wireless Device, Patient and Dentist interaction System, according to claim 14, wherein the system acts on connecting with the patient's device, through a flow with a group for the patient (P).

49: Wireless Device, Patient and Dentist Interaction System, according to claim 14, wherein the system acts on the reception of alerts regarding the treatment of active patients, through a R&D flow with one group for the system (46) and another for the dentist (D1) system application.
